(19) United States
(12) Patent Application Publication
(10) Pub. No.: US 2017/0189856 A1
(43) Pub. Date: Jul. 6, 2017

(54) MANUFACTURING METHOD AND MANUFACTURING APPARATUS FOR HOLLOW FIBER MEMBRANE SHEET, AS WELL AS HOLLOW FIBER MEMBRANE SHEET

(71) Applicant: MITSUBISHI RAYON CO., LTD., Tokyo (JP)

(72) Inventors: Makoto IDEGUCHI, Toyohashi-shi (JP); Osamu MAEHARA, Toyohashi-shi (JP); Nobuyasu UENO, Toyohashi-shi (JP); Toshinori TANAKA, Toyohashi-shi (JP)

(73) Assignee: Mitsubishi Rayon Co., Ltd., Tokyo (JP)

(21) Appl. No.: 15/315,565

(22) PCT Filed: May 15, 2015
(86) PCT No.: PCT/JP2015/064030

§ 371 Date: Dec. 1, 2016

(30) Foreign Application Priority Data
Jun. 6, 2014 (JP) 2014-117996

(51) Int. Cl. B01D 63/02; B32B 38/00; B32B 5/24; B32B 37/06; B32B 27/00; B01D 63/04; B32B 37/12

(52) U.S. Cl. CPC B01D 63/021; B01D 63/043; B32B 38/0004; B32B 37/12; B32B 37/06; B32B 27/00; B32B 5/24

(57) ABSTRACT

The present invention relates to a manufacturing method for a hollow fiber membrane sheet comprising: accepting a hollow fiber membrane bundle, which is in a sheet state, of a length set in advance in which a plurality of hollow fiber membranes are aligned using one or more accepting means containing a drive roll; forming fixing parts at which the hollow fiber membranes are fixed in a widthwise direction of the hollow fiber membrane bundle using a fixing means after accepting the hollow fiber membrane bundle of the length set in advance; and cutting the hollow fiber membrane bundle at the fixing parts or on the vicinity thereof.

### TECHNICAL FIELD

The present invention relates to a manufacturing method and a manufacturing apparatus for a hollow fiber membrane sheet and a hollow fiber membrane sheet acquired using the manufacturing method.

This application claims priority from Japanese Patent Application No. 2014-117996 filed on Jun. 6, 2014, the disclosure of which is incorporated by reference in its entirety.

### BACKGROUND ART

Hollow fiber membrane modules are used for various purposes such as manufacturing of sterile water, beverages, or high-degree pure water, purification of the air, a drainage process, and the like. As one type of the hollow fiber membrane modules, a hollow fiber module is known which contains a hollow fiber membrane sheet in which a plurality of hollow fiber membranes are aligned in one direction and a water collecting member fixing the hollow fiber membrane sheet in the state of housing both end portions of the hollow fiber membranes of the hollow fiber membrane sheet in the longitudinal direction inside.

The hollow fiber membrane sheet contains: a sheet-state hollow fiber membrane bundle in which a plurality of hollow fiber membranes are aligned in one direction; binding yarn formed in both end portions of the hollow fiber membranes of the hollow fiber membrane bundle in the longitudinal direction or in the vicinity thereof; and fixing parts fixing the hollow fiber membranes through welding of the hollow fiber membranes or using an adhesive resin.

As examples of a method of manufacturing a hollow fiber membrane sheet, the following methods are known.

(1) a method of manufacturing a hollow fiber membrane sheet of a raschel knitted fabric in which while a hollow fiber membrane that is a weft is folded at a length set in advance by using a raschel knitting machine, folded portions on both sides are bound using a warp of a chain stitch (Patent Literature 1)
(2) a method of continuously manufacturing a hollow fiber membrane sheet by alternately repeating a series of operations of holding and pulling out a hollow fiber membrane bundle, forming a fixing operation, and cutting by using a first holding unit and a series of operations of holding and pulling out a hollow fiber membrane bundle, forming a fixing operation, and cutting by using a second holding unit by using a manufacturing apparatus having a holding means for holding the sheet-state hollow fiber membrane bundle in which hollow fiber membranes are aligned in one direction, a fixing means for forming fixing parts at which the hollow fiber membranes are fixed in the widthwise direction of the hollow fiber membrane bundle, and a cutting means for cutting the hollow fiber membrane bundle at the fixing parts, the first holding unit configured to be movable along the longitudinal direction of the hollow fiber membranes so as to pull out the hollow fiber membrane bundle and the similar second holding unit (Patent Literature 2).

However, there are the following problems in the method (1).

Since the structure of the raschel knitting machine is complex, the price of the manufacturing apparatus is high.

In a case where the length of the hollow fiber membrane sheet is changed, the folding position of the hollow fiber membrane that is a weft and the position of a means for supplying a key needle and the warp installed at the folding position need to be changed, and the changing operation is complex.

In a case where the number of hollow fiber membranes per one hollow fiber membrane sheet is increased, the number of times of folding of the hollow fiber membranes is increased to that extent. For this reason, it takes time for the manufacturing process, and the productivity decreases.

In the method (2), there are the following problems.

It is required to build the holding means, the fixing means, and the cutting means in the holding unit, and a moving mechanism of the holding unit is necessary, whereby the structure of the manufacturing apparatus is complicated. For this reason, the price of the manufacturing apparatus is high.

When the hollow fiber membrane bundle is pulled out, a tensile force is applied to each of a plurality of hollow fiber membranes. The tensile force applied to each of the plurality of hollow fiber membranes is slightly different for each hollow fiber membrane based on the winding quantity of each bobbin supplying the hollow fiber membrane, the brake strength of each bobbin, and the like. In addition, also in a case where the same tensile force is applied, a material or a manufacturing condition is different according to a production lot, and, based on a difference in the manufacturing condition according to time or the like for the same production lot, stretching easiness is slightly different for each hollow fiber membrane. Since the tensile force or the stretching easiness is different for each hollow fiber membrane, when a tensile force is applied, the stretching state is different for each hollow fiber membrane. For this reason, in a case where a plurality of hollow fiber membranes that are in mutually-different stretched states are pulled out at a length set in advance and fixed and then, are cut out, the plurality of hollow fiber membranes released from the stretched states contract to mutually-different degrees, and accordingly, unbalance occurs in the lengths of the hollow fiber membranes.

### CITATION LIST

### Patent Literature

Patent Literature 1: JP 2008-196066 A

Patent Literature 2: JP 2012-120984 A

### SUMMARY OF THE INVENTION

### Problem to be Solved by the Invention

The invention provides: a method of manufacturing a hollow fiber membrane sheet not requiring a manufacturing apparatus having a complicated structure, being capable of easily changing a length of the hollow fiber membrane sheet, and having productivity that is not decreased also in a case where the number of hollow fiber membranes per one hollow fiber sheet is increased; a manufacturing apparatus for manufacturing a hollow fiber membrane sheet having a simple structure, is capable of changing a length of the hollow fiber membrane sheet, and having productivity that is not decreased also in a case where the number of hollow fiber membranes per one hollow fiber sheet is increased; and a hollow fiber membrane sheet having small unbalance in the lengths of hollow fiber membranes.

### Means for Solving Problem

The invention has the following aspects.

<1> A method of manufacturing a hollow fiber membrane sheet, the method comprising: accepting a hollow fiber membrane bundle, which is in a sheet state, of a length set in advance in which a plurality of hollow fiber membranes are aligned using one or more accepting means containing a drive roll; forming fixing parts at which the hollow fiber membranes are fixed in a widthwise direction of the hollow fiber membrane bundle using a fixing means after accepting the hollow fiber membrane bundle of the length set in advance; and cutting the hollow fiber membrane bundle at the fixing parts or on the vicinity thereof

<2> The method according to <1>, wherein at least one of the accepting means is a nip roll pair configured by one pair of rolls.

<3> The method according to <1> or <2>, wherein the number of the accepting means is two, and the fixing means is arranged between the two accepting means.

<4> The method according to any one of <1> to <3>, further comprising: pulling out a plurality of the hollow fiber membranes from a hollow fiber membrane supplying unit using a pulling-out means, wherein the plurality of the hollow fiber membranes pulled out by the pulling-out means are accepted as the hollow fiber membrane bundle using the accepting means.

<5> The method according to <4>, wherein a length of the hollow fiber membranes present from the pulling-out means to the accepting means is configured to be longer than a shortest distance of an actual passage from the pulling-out means to the accepting means by 1 mm or more.

<6> The method according to <4>, wherein, before the hollow fiber membrane bundle is accepted by using the accepting means, a length of the hollow fiber membranes present from the hollow fiber membrane supplying unit to the accepting means to be longer than a shortest distance of an actual passage from the hollow fiber membrane supplying unit to the accepting means by a length set in advance that is accepted by the accepting means or more.

<7> The method according to <4>, wherein the pulling-out means is a movable roll that is movable in a vertical direction between two guide rolls, wherein, before the hollow fiber membrane bundle is accepted by using the accepting means, by pushing down the hollow fiber membranes stretched over between the two guide rolls using the movable roll, a length of the hollow fiber membranes present between the guide rolls is configured to be longer than a distance between the guide rolls before and after the pulling-out means by a length set in advance that is accepted by the accepting means or more, and wherein, when the hollow fiber membrane bundle is accepted by using the accepting means, the movable roll is saved so as not to be in contact with the hollow fiber membranes.

<8> The method according to any one of <1> to <4>, wherein a tensile force applied to the hollow fiber membranes present on a further upstream side in a conveyance direction of the hollow membrane bundle than the accepting means is set to a tensile force not stretching the hollow fiber membranes above an allowed range represented below.

Allowed Range: an allowed range of a difference between a length of a longest hollow fiber membrane and a length of a shortest hollow fiber membrane in the hollow fiber membrane sheet

<9> The method according to any one of <1> to <8>, wherein a hollow fiber membrane bundle of a sheet state is formed by aligning the plurality of the hollow fiber membranes using an aligning means.

<10> A manufacturing apparatus for a hollow fiber membrane sheet, the manufacturing apparatus comprising: one or more accepting means, which contains a drive roll, accepting a hollow fiber membrane bundle of a sheet state in which a plurality of hollow fiber membranes are aligned; a fixing means that forms fixing parts at which the hollow fiber membranes are fixed in a widthwise direction of the hollow fiber membrane bundle; and a control means that accepts the hollow fiber membrane bundle of a length set in advance by operating the accepting means to accept the hollow fiber membrane bundle of the length set in advance and then, stops the accepting means and operates the fixing means.

<11> The manufacturing apparatus for a hollow fiber membrane sheet according to <10>, further comprising a cutting means that cuts the hollow fiber membrane bundle at the fixing parts or on the vicinity thereof

<12> The manufacturing apparatus for a hollow fiber membrane sheet according to <10> or <11>, wherein at least one of the accepting means is a nip roll pair configured by one pair of rolls.

<13> The manufacturing apparatus for a hollow fiber membrane sheet according to any one of <10> to <12>, wherein the number of the accepting means is two, and the fixing means is arranged between the two accepting means.

<14> The manufacturing apparatus for a hollow fiber membrane sheet according to any one of <10> to <13>, further comprising: a hollow fiber membrane supplying unit in which the hollow fiber membranes are stored; and a pulling-out means that pulls out a plurality of hollow fiber membranes from the hollow fiber membrane supplying unit, wherein the accepting means accepts the plurality of hollow fiber membranes pulled out by the pulling-out means as the hollow fiber membrane bundle.

<15> The manufacturing apparatus for a hollow fiber membrane sheet according to <14>, wherein the control means performs control of the pulling-out means and the accepting means such that a length of the hollow fiber membranes present from the pulling-out means to the accepting means is configured to be longer than a shortest distance of an actual passage from the pulling-out means to the accepting means by 1 mm or more.

<16> The manufacturing apparatus for a hollow fiber membrane sheet according to <14>, wherein the pulling-out means is a movable roll that is movable in a vertical direction between two guide rolls, and wherein the control means, while the accepting means is stopped, moves the movable roll to a lower side so as to push down the hollow fiber membranes stretched over between the two guide rolls until a length of the hollow fiber membranes present between the guide rolls becomes longer than a distance between the guide rolls before and after the pulling-out means by a length set in advance that is accepted by the accepting means or more and, while the accepting means is operated, saves the movable roll so as not to be in contact with the hollow fiber membranes.

<17> The manufacturing apparatus for a hollow fiber membrane sheet according to any one of <10> to <14>, wherein the control means performs control of the accepting means such that a tensile force applied to the hollow fiber membranes present on a further upstream side in a conveyance direction of the hollow membrane bundle than the accepting means is set to a tensile force not stretching the hollow fiber membranes above an allowed range represented below.

Allowed Range: an allowed range of a difference between a length of a longest hollow fiber membrane and a length of a shortest hollow fiber membrane in the hollow fiber membrane sheet

<18> The manufacturing apparatus for a hollow fiber membrane sheet according to any one of <10> to <17>, further comprising an aligning means that forms a hollow fiber membrane bundle of a sheet state by aligning the plurality of the hollow fiber membranes.

<19> A hollow fiber membrane sheet acquired using the method of manufacturing a hollow fiber membrane sheet according to any one of <5> to <8>, wherein a difference between a length of a longest hollow fiber membrane and a length of a shortest hollow fiber membrane in the hollow fiber membrane sheet is 0.5% of the length set in advance or less.

### Effect of the Invention

According to a method of manufacturing a hollow fiber membrane sheet of the invention, a manufacturing apparatus having a complicated structure is not required, the length of the hollow fiber membrane sheet can be easily changed, and the productivity is not decreased also in a case where the number of hollow fiber membranes per one hollow fiber sheet is increased.

A manufacturing apparatus manufacturing a hollow fiber membrane sheet of the invention has a simple structure. According to a manufacturing apparatus for manufacturing a hollow fiber membrane sheet, the length of the hollow fiber membrane sheet can be easily changed, and the productivity is not decreased also in a case where the number of hollow fiber membranes per one hollow fiber sheet is increased.

In addition, a hollow fiber membrane sheet of the invention has small unbalance in the lengths of hollow fiber membranes.

### BRIEF DESCRIPTION OF DRAWINGS

FIG. 1 is a front view that illustrates an example of a hollow fiber membrane sheet;

FIG. 2 is a schematic diagram that illustrates an accepting step according to a first embodiment of the invention;

FIG. 3 is a schematic diagram that illustrates a fixing step and a cutting step according to the first embodiment of the invention;

FIG. 4 is a schematic diagram that illustrates an accepting step according to a second embodiment of the invention;

FIG. 5 is a schematic diagram that illustrates a fixing step and a cutting step according to the second embodiment of the invention;

FIG. 6 is a schematic diagram that illustrates a fixing step, a cutting step, and a pulling-out step according to a third embodiment of the invention; and

FIG. 7 is a schematic diagram that illustrates an accepting step according to the third embodiment of the invention.

### MODE(S) FOR CARRYING OUT THE INVENTION

The following definitions of terms are applied to this specification and the claims.

A “drive roll” represents a roll configured to be driven to be rotatable according to a drive force supplied from a rotation drive source such as a motor.

A “free roll” represents a roll, which does not have a rotation drive source, rotated in following with the rotation of another roll, conveyance of a hollow fiber membrane, or the like.

A “movable roll” represents a roll that is configured to be movable in a predetermined direction inside a space by a moving means or the like.

A “length set in advance” is a length that is a target length of a hollow fiber membrane sheet acquired finally. The length set in advance can be set in an arbitrary range.

A “fiber passage” represents a route, which is formed by arranging rolls in a space, through which a hollow fiber membrane is conveyed.

“A shortest distance of a fiber passage from a pulling-out means (hollow fiber membrane supplying unit) to an accepting means” represents a length of a hollow fiber membrane from an outlet of the pulling-out means (an outlet of the hollow fiber membrane supplying unit) to an inlet of the accepting means in a state in which, after a hollow fiber membrane is stretched over rolls arranged in a space so as to follow the fiber passage, a tensile force is applied to the hollow fiber membrane (a not relaxed state).

“A length of a hollow fiber membrane present from the pulling-out means (hollow fiber membrane supplying unit) to the accepting means” represents a length of the hollow fiber membrane present from the outlet of the pulling-out means (the outlet of the hollow fiber membrane supplying unit) to the inlet of the accepting means.

An “allowed range” represents a target upper limit value of a difference (a longest length a shortest length) between a length of a longest hollow fiber membrane and a length of a shortest hollow fiber membrane in the hollow fiber membrane sheet.

A “sheet state” represents a state in which a plurality of hollow fiber membranes are aligned in the longitudinal direction.

A “hollow fiber membrane bundle” represents a plurality of hollow fiber membranes.

“A length of a hollow fiber membrane sheet” represents a length of hollow fiber membranes configuring the hollow fiber membrane sheet in the longitudinal direction.

“A widthwise direction of a hollow fiber membrane sheet” represents a direction orthogonal to the longitudinal direction of hollow fiber membranes configuring the hollow fiber membrane sheet.

In the drawings, an arrow represented in each drive roll represents that the drive roll is driven to rotate.

<Hollow Fiber Membrane Sheet>

A hollow fiber membrane sheet acquired using a manufacturing method according to the invention contains: a hollow fiber membrane bundle of a sheet state in which a plurality of hollow fiber membranes are aligned; and fixing parts, which are formed in both end portions of the hollow fiber membrane bundle in the longitudinal direction of the hollow fiber membranes or in the vicinity thereof, fixing the hollow fiber membranes using welding of the hollow fiber membranes, an adhesive resin, an adhesive tape, a binding yarn, a jig, or the like.

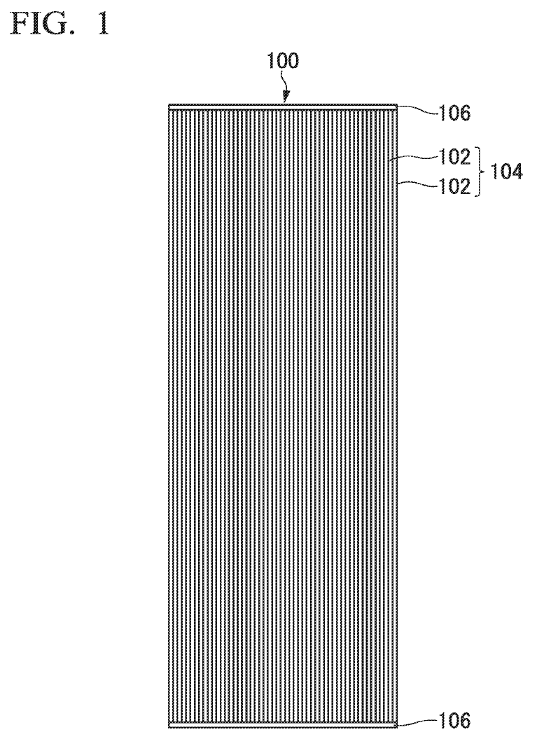

FIG. 1 is a front view that illustrates an example of a hollow fiber membrane sheet.

The hollow fiber membrane sheet 100 contains: a hollow fiber membrane bundle 104 of a sheet state in which a plurality of hollow fiber membranes 102 are aligned; and fixing parts 106, which are formed in both end portions of the hollow fiber membrane bundle 104 in the longitudinal direction of the hollow fiber membranes 102 over the widthwise direction of the hollow fiber membrane bundle 104, fixing the hollow fiber membranes 102 through welding of the hollow fiber membranes 102.

An example of the material of the hollow fiber membrane 102 is a resin composite including polymer such as polysulfone, polyacrylonitrile, cellulose derivatives, polyolefin (polyethylene, polypropylene, or the like), a fluororesin-based resin (polyvinylidene fluoride, polytetrafluoroethylene, or the like), polyamide, polyester, polymethacrylate, or polyacrylate as its major component. Such polymers may be polymers in which a substituent is introduced in part. The resin composite may contain two types of polymers or more. The resin composite may contain carbide such as polyvinylpyrrolidone.

The hollow fiber membrane 102 may be a membrane that can be used as a filtration membrane, and the hole diameter, the porosity, the membrane thickness, the outer diameter, and the like thereof are not particularly limited. As the hollow fiber membrane 102, for example, a hollow fiber membrane having the outer diameter in the range of 20 to 4000 μm, the pore diameter in the range of 0.001 to 5 μm, and the porosity in the range of 20 to 90%, and the membrane thickness in the range of 5 to 300 μm is preferably used. The hollow fiber membrane 102 may be a mono-filament or a multi-filament in which a plurality of hollow fiber membranes are doubled as long as it can be supplied as one yarn body.

The number of the hollow fiber membranes 102 per one hollow fiber sheet 100 is appropriately set based on the performance required for a hollow fiber membrane module, the size of the hollow fiber membrane module, and the like.

A difference (a longest length a shortest length) between the length of a longest hollow fiber membrane 102 and the length of a shortest hollow fiber membrane 102 in the hollow fiber membrane sheet 100 is preferably 0.5% of the length set in advance or less and is more preferably 0.3% or less. In a case where the difference described above is 0.5% of the length set in advance or less, the unbalance in the lengths of the hollow fiber membranes 102 in a hollow fiber membrane module that is finally acquired is small. As a result, when the hollow fiber membrane module is used, there are effects that a damage in hollow fiber membranes 102 due to friction between loose hollow fiber membranes 102 and a frame of the hollow fiber membrane module unit is suppressed, entanglement between loose hollow fiber membranes 102 is suppressed, the number of the loose hollow fiber membranes 102 is decreased, and the cleaning effect can be sufficiently acquired through air bubbling, and the like.

The hollow fiber membrane sheet 100 of which the difference is 0.5% of the length set in advance or less, for example, can be manufactured using a manufacturing method according to a form (β) to be described later.

<Method of Manufacturing Hollow Fiber Membrane Sheet>

A method of manufacturing a hollow fiber membrane sheet according to the invention is a method that includes an accepting step (S1) to be described below, a fixing step (S2) to be described below, and a cutting step (S3) to be described below.

(S1) a step of accepting a hollow fiber membrane bundle of a length set in advance, which is in a sheet state, in which a plurality of hollow fiber membranes are aligned by using one accepting means containing a drive roll or more
(S2) After the hollow fiber membrane bundle of the length set in advance is accepted, in a state in which the accepting means is stopped, a step of forming fixing parts at which hollow fiber membranes are fixed in the widthwise direction of the hollow fiber membrane bundle by using the fixing means
(S3) a step of cutting the hollow fiber membrane bundle at the fixing parts or in the vicinity thereof

In the invention, (a) a method in which, in the cutting step (S3), the fixing parts formed in the fixing step (S2) of the previous time or the vicinity thereof is cut, and, after performing the accepting step (S1), performing the fixing step (S2) and the cutting step (S3) at the same time is repeated, (b) a method in which performing of the accepting step (S1), the fixing step (S2), and the cutting step (S3) in a sequential manner is repeated, or (c) a method in which, after repeatedly performing the accepting step (S1) and the fixing step (S2), only the cutting step (S3) is repeatedly performed may be employed. From the point of the productivity, the method (a) is preferable.

In addition, the method of manufacturing the hollow fiber membrane sheet according to the invention is largely divided into (α) a form in which hollow fiber membranes that are present on a further upstream side than the accepting means in the conveyance direction of the hollow fiber membrane bundle are accepted by the accepting means in the stretched state and (β) a form in which hollow fiber membranes that are present on a further upstream side than the accepting means in the conveyance direction of the hollow fiber membrane bundle are accepted by the accepting means in the loose state. The form (β) is preferable from a point that the hollow fiber membrane sheet having small unbalance in the lengths of the hollow fiber membranes can be acquired.

Hereinafter, methods of manufacturing a hollow fiber membrane sheet according to the invention will be described in detail while illustrating the method (a) of the form (α), in other words, a first embodiment and the method (a) of the form (β), in other words, a second embodiment and a third embodiment.

### FIRST EMBODIMENT

(Manufacturing Apparatus for Manufacturing Hollow Fiber Membrane Sheet)

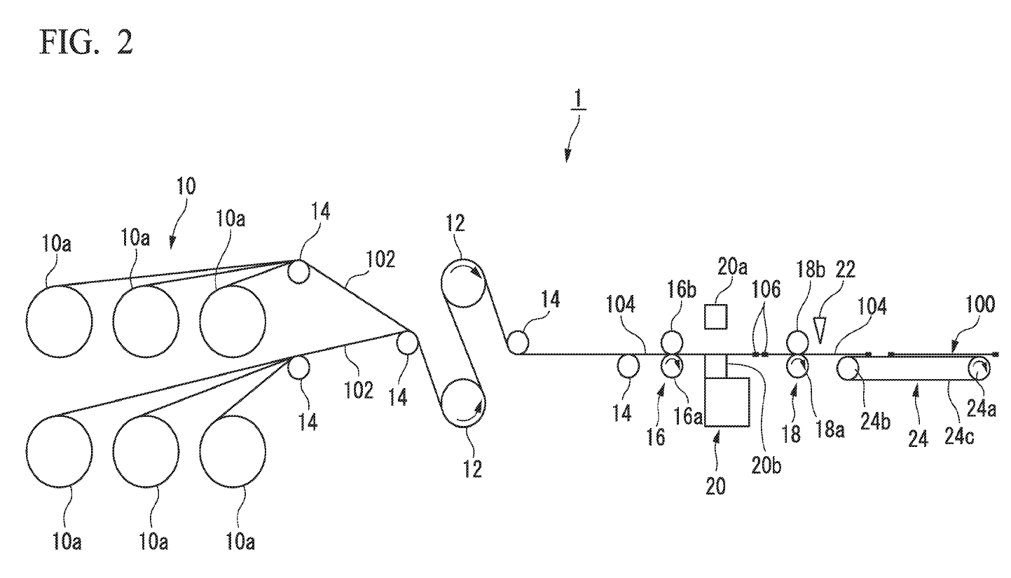

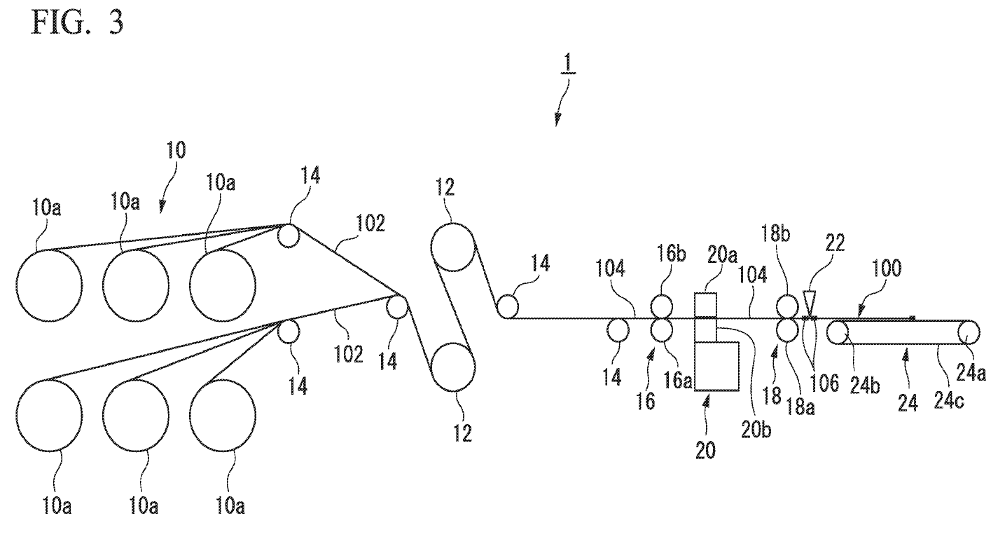

FIGS. 2 and 3 are schematic diagrams that illustrate a manufacturing apparatus for manufacturing a hollow fiber membrane sheet used in the first embodiment of the invention. More specifically, FIG. 2 is a schematic diagram that illustrates an accepting step (S1) according to the first embodiment of the invention, and FIG. 3 is a schematic diagram that illustrates a fixing step (S2) and a cutting step (S3) according to the first embodiment of the invention.

The manufacturing apparatus 1 contains: a hollow fiber membrane supplying unit 10 that stores hollow fiber membranes 102; two drive rolls 12 (pulling-out means), which are vertically arranged in parallel with each other, pulling out a plurality of hollow fiber membranes 102 from the hollow fiber membrane supplying unit 10; a plurality of guide rolls 14 (aligning means), which are arranged on the upstream side and the downstream side in the conveyance direction of the hollow fiber membrane 102 with respect to the drive rolls 12, forming a hollow fiber membrane bundle 104 of a sheet state by aligning a plurality of the hollow fiber membranes 102; a first nip roll pair 16 (accepting means) that accepts the hollow fiber membrane bundle 104 of a sheet state formed by aligning a plurality of the hollow fiber membranes 102 pulled out by the drive rolls 12 by using the guide rolls 14; a second nip roll pair 18 (accepting means) that further accepts the hollow fiber membrane bundle 104 of a sheet state accepted by the first nip roll pair 16; an impulse heater 20 (fixing means) that forms fixing parts 106 of two places, which are arranged between the first nip roll pair 16 and the second nip roll pair 18, at which the hollow fiber membranes 102 are fixed in the widthwise direction of the hollow fiber membrane bundle 104 with a slight gap being arranged; an ultrasonic cutter 22 (cutting means), which is arranged on a further downstream side in the conveyance direction of the hollow fiber membranes 102 than the second nip roll pair 18, cutting the hollow fiber membrane bundle 104 in the gap between the fixing parts 106 of two places; a belt conveyer 24 (discharging means) that discharges the hollow fiber membrane sheet 100 acquired by cutting the hollow fiber membrane bundle 104 by using the ultrasonic cutter 22 to the outside of the manufacturing apparatus 1; and a control means (not illustrated in the drawing) that accepts the hollow fiber membrane bundle 104 of a length set in advance by operating the first nip roll pair 16 and the second nip roll pair 18 so as to accept the hollow fiber membrane bundle 104 of a length set in advance and then stops the first nip roll pair 16 and the second nip roll pair 18 and operates the impulse heater 20 and the ultrasonic cutter 22.

Hollow Fiber Membrane Supplying Unit

The hollow fiber membrane supplying unit 10 contains: a creel stand (not illustrated in the drawings) having a creel (not illustrated in the drawing); a bobbin 10a set in the creel stand; and a brake (not illustrated in the drawing) applying torque set in advance to the bobbin 10a so as to prevent a wheel slip of the bobbin 10a. The creel, the bobbin 10a, and the brake corresponding to the number of the hollow fiber membranes 102 configuring the hollow fiber membrane sheet 100 are required.

Pulling-Out Means

Regarding the drive rolls 12, a plurality of hollow fiber membranes 102 are pulled out from the hollow fiber membrane supplying unit 10 by driving the two drive rolls 12 to rotate in a state in which a plurality of hollow fiber membranes 102 stretched in the shape of “S” over the drive rolls 12 are brought into contact with the peripheral faces of the drive rolls 12. A rotation drive source such as a motor is connected to the drive rolls 12.

As the material of the peripheral faces of the drive rolls 12, a material not causing a damage on the surface of the hollow fiber membranes 102 and not causing the hollow fiber membranes 102 to slip thereon is preferable, and, more specifically, a metal is preferable.

From the point of not causing a damage on the surface of the hollow fiber membranes 102 and not causing the hollow fiber membranes 102 to slip thereon, the peripheral faces of the drive rolls 12 preferably have low surface roughness (arithmetic average roughness Ra: 6.3 μm or less, JIS B 0601: 2001) and are more preferably finished in a mirror surface shape.

On the peripheral faces of the drive rolls 12, a plurality of grooves extending in the peripheral direction may be formed not to cause any unbalance in the gap between the hollow fiber membranes 102.

Aligning Means

Until the hollow fiber membranes 102 are pulled out from the hollow fiber membrane supplying unit 10 and are accepted by the first nip roll pair 16, the plurality of the guide rolls 14 gradually decrease the gap between the plurality of the hollow fiber membranes 102, thereby aligning the plurality of the hollow fiber membranes 102 to be a hollow fiber membrane bundle 104 of a sheet state.

Among a plurality of the guide rolls 14, it is preferable that at least one guide roll 14 is a roll (gap adjusting means) used for gap adjustment.

On the peripheral face of the roll used for gap adjustment, a plurality of grooves extending in the peripheral direction and independently extending in the peripheral direction in parallel at a gap that is the same as the hollow fiber membranes 102 of the hollow fiber membrane sheet 100 are formed.

The gap between the grooves is determined based on the diameter of the hollow fiber membranes 102 and the integration density of the hollow fiber membrane sheet 100.

The width of the grooves is preferably larger than the diameter of the hollow fiber membranes 102 by one size (1 to 3%) or more for making it difficult to cause quality degradation due to a contact between adjacent hollow fiber membranes 102 to occur, a deviation of the gap, entanglement, or the like.

The shape of the groove may be a semi-circle shape, a shape of “V”, or a trapezoidal shape having a short base in the cross-section that is orthogonal to the peripheral direction. The semi-circle shape is more preferable from a point for bringing the hollow fiber membranes 102 and the grooves into close contact with each other.

Accepting Means

The first nip roll pair 16 accepts the hollow fiber membrane bundle 104 of a sheet state that is aligned by the guide rolls 14 for a length set in advance under the control of a control means to be described later.

The first nip roll pair 16 contains a drive roll 16a and a free roll 16b. A rotation drive source such as a motor is connected to the drive roll 16a.

The second nip roll pair 18 further accepts the hollow fiber membrane bundle 104 of a sheet state accepted by the first nip roll pair 16 and forms a state in which the hollow fiber membrane bundle 104 of a sheet state is stretched between the first nip roll pair 16 and the second nip roll pair 18, thereby suppressing an occurrence of unbalance between the gap between the hollow fiber membranes 102 of the hollow fiber membrane bundle 104 and loosening of the hollow fiber membranes 102 to cause unbalance in the lengths of the hollow fiber membranes 102.

The second nip roll pair 18 contains a drive roll 18a and a free roll 18b. A rotation drive source such as a motor is connected to the drive roll 18a.

As the material of the peripheral face of each roll of the nip roll pair, a material that appropriately transforms at the time of applying a nip weight thereto is preferable. Examples of the material include various kinds of rubber (urethane rubber, silicon rubber, fluororubber, natural rubber, butyl rubber, ethylene propylene rubber, a chloroprene rubber, and the like), sponge made of various kinds of rubber, soft polyurethane, soft polyvinyl chloride, and foam (polyethylene, polystyrene, ethylene-vinyl acetate copolymer, and the like).

Fixing Means

The impulse heater 20 contains a crimping lever 20a and a seal receiving base 20b. The hollow fiber membrane bundle 104 is interposed between the crimping lever 20a and the seal receiving base 20b, and the surfaces of the hollow fiber membranes 102 are melted using a heater (not illustrated in the drawing) disposed in the seal receiving base 20b, and the hollow fiber membranes 102 are welded in the widthwise direction of the hollow fiber membrane bundle 104, whereby fixing parts 106 of two places at which the hollow fiber membranes 102 are fixed are formed with a slight gap arranged therein.

The impulse heater 20 is arranged between the first nip roll pair 16 and the second nip roll pair 18. By arranging as such, the fixing parts 106 can be formed in a state in which the hollow fiber membrane bundle 104 of a sheet state is stretched over between the first nip roll pair 16 and the second nip roll pair 18. For this reason, the fixing parts 106 can be formed in a state in which unbalance in the gap between the hollow fiber membranes 102 of the hollow fiber membrane bundle 104 and unbalance in the lengths of the hollow fiber membranes 102 are suppressed.

Cutting Means

The ultrasonic cutter 22 is arranged to leave a same distance as the length of the hollow fiber membrane sheet 100, which is set in advance, from the impulse heater 20 on a further downstream side in the conveyance direction of the hollow fiber membranes 102 than the impulse heater 20. By arranging as such, after the hollow fiber membrane bundle 104 is accepted for a length set in advance by the first nip roll pair 16 and the second nip roll pair 18 by the control means to be described later, when the fixing parts 106 are formed in the hollow fiber membrane bundle 104 by the impulse heater 20, the fixing parts 106 formed in the fixing step (S2) of the previous step is precisely positioned at the ultrasonic cutter 22. For this reason, the formation of the fixing parts 106 of two places using the impulse heater 20 and the cutting of the hollow fiber membrane bundle 104 in the gap between the fixing parts 106 of two places using the ultrasonic cutter 22 can be simultaneously performed.

Discharging Means

The belt conveyer 24 discharges the hollow fiber membrane sheet 100 acquired by cutting the hollow fiber membrane bundle 104 using the ultrasonic cutter 22 to the outside of the manufacturing apparatus 1 without causing the hollow fiber membrane sheet to stay near the ultrasonic cutter 22.

The belt conveyer 24 contains a drive roll 24a, a free roll 24b, and an endless belt 24c stretched over the drive roll 24a and the free roll 24b. A rotation drive source such as a motor is connected to the drive roll 24a.

Tensile Force Measuring Means

The manufacturing apparatus 1 may further contain a tensile force measuring means (not illustrated in the drawing) that measures a tensile force applied to the hollow fiber membrane 102 present between the drive roll 12 and the first nip roll pair 16.

The tensile force measuring means is disposed between the drive roll 12 and the first nip roll pair 16.

Examples of the tensile force measuring means includes a magnetic amplification-type tension meter, a spring-displacement type tension meter, an air-pressure type tension meter, and the like.

Control Means

By controlling the first nip roll pair 16, the second nip roll pair 18, the impulse heater 20, and the ultrasonic cutter 22, the control means (not illustrated in the drawing) causes the first nip roll pair 16 and the second nip roll pair 18 to accept the hollow fiber membrane bundle 104 for a length set in advance, and thereafter, by operating the impulse heater 20 and the ultrasonic cutter 22 in the state in which the first nip roll pair 16 and the second nip roll pair 18 are stopped, forms fixing parts 106 of two places in the hollow fiber membrane bundle 104 using the impulse heater 20 and, simultaneously, cuts the hollow fiber membrane bundle 104 in the gap between the fixing parts 106 of two places formed in the fixing step (S2) of the previous time by using the ultrasonic cutter 22.

In addition, the control means may control the rotation speeds of the drive rolls 12 and the first nip roll pair 16 based on tensile force information supplied from the tensile force measuring means such that a tensile force applied to the hollow fiber membranes 102 present between the drive roll 12 and the first nip roll pair 16 is a tensile force for which the hollow fiber membranes 102 are not stretched above an allowed range described below. By controlling as such, the unbalance in the lengths of the hollow fiber membranes 102 of the hollow fiber membrane sheet 100 is small.

Allowed Range: an allowed range of a difference between the length of a longest hollow fiber membrane 102 and the length of a shortest hollow fiber membrane 102 in the hollow fiber membrane sheet 100

The control means contains a processing unit (not illustrated in the drawing), an interface unit (not illustrated in the drawings), and a storage unit (not illustrated in the drawings).

The interface unit electrically connects the rotation drive source of the drive rolls 12, the rotation drive source of the drive roll 16a of the first nip roll pair 16, the rotation drive source of the drive roll 18a of the second nip roll pair 18, the impulse heater 20, the ultrasonic cutter 22, the rotation drive source of the drive roll 24a of the belt conveyer 24, and the tensile force measuring means and the processing unit.

The processing unit controls each means based on settings (the length of the hollow fiber membrane sheet 100 that is set in advance, an upper limit value of the tensile force applied to the hollow fiber membrane 102 present between the drive roll 12 and the first nip roll pair 16, the rotation speed of each drive roll, the operation times of the impulse heater 20 and the ultrasonic cutter 22, and the like) and the like stored in the storage unit.

In addition, the processing unit may be realized by dedicated hardware. Furthermore, the processing unit may be configured by a memory and a central processing unit (CPU) and realize the function by loading a program used for realizing the function of the processing unit into a memory and executing the program.

An input device, a display device, and the like as peripheral devices are connected to the control means. Here, the input device may be an input device such as a display touch panel, a switch panel, or a keyboard, and the display represents a CRT, a liquid crystal display device, or the like.

(Method of Manufacturing Hollow Fiber Membrane Sheet)

Hereinafter, a method of manufacturing a hollow fiber membrane sheet according to the first embodiment of the invention using the manufacturing apparatus 1 will be described with reference to the drawings.

The method of manufacturing a hollow fiber membrane sheet according to the first embodiment of the invention includes an accepting step (S1) to be described below, a fixing step (S2) to be described below, and a cutting step (S3) to be described below.

(S1) a step of pulling out a plurality of hollow fiber membranes 102 from the hollow fiber membrane supplying unit 10 by using the drive rolls 12, aligning the plurality of hollow fiber membranes 102 that have been pulled out to be a hollow fiber membrane bundle 104 of a sheet state by using a plurality of the guide rolls 14, and accepting the hollow fiber membrane bundle 104 by using the first nip roll pair 16 and the second nip roll pair 18

(S2) a step of, after accepting the hollow fiber membrane bundle 104 for a length set in advance, forming fixing parts 106 of two places at which the hollow fiber membranes 102 are fixed in the widthwise direction of the hollow fiber membrane bundle 104 by using the impulse heater 20 in a state in which the drive rolls 12, the first nip roll pair 16 and the second nip roll pair 18 are stopped

(S3) a step of cutting the hollow fiber membrane bundle 104 in the gap between the fixing parts 106 of two places by using the ultrasonic cutter 22

In the first embodiment, in the cutting step (S3), the gap between the fixing parts 106 of two places formed in the fixing step (S2) of the previous time are cut, and, a series of flows of simultaneously performing the fixing step (S2) and the cutting step (S3) after performing the accepting step (S1) is repeatedly performed.

Accepting Step (S1)

FIG. 2 is a schematic diagram that illustrates the accepting step S1) according to the first embodiment of the invention.

The drive rolls 12 are driven to rotate, and a plurality of hollow fiber membranes 102 are pulled out from the hollow fiber membrane supplying unit 10. Since torque set in advance is applied to the bobbin 10a by using the brake so as to prevent a wheel slip of the bobbin 10a, a tensile force is applied to the hollow fiber membranes 102 between the hollow fiber membrane supplying unit 10 and the drive rolls 12.

The tensile force applied to the hollow fiber membranes 102 between the hollow fiber membrane supplying unit 10 and the drive roll 12 is appropriately set based on the material, the rigidity, the outer diameter, and the like of the hollow fiber membranes 102 and is preferably in the range of 0.098 to 9.8 N and is more preferably in the range of 0.49 to 7.35 N, and is further more preferably in the range of 0.98 to 4.9 N. When the tensile force is too low, there is concern that, based on an inertial force at the time of stopping the drive rolls 12, the hollow fiber membranes 102 are excessively unwound from the bobbin 10a, or the hollow fiber membranes 102 deviate from the guide rolls 14. On the other hand, when the tensile force is too high, there is concern that the hollow fiber membranes 102 are damaged.

A plurality of hollow fiber membranes 102 pulled out from the hollow fiber membrane supplying unit 10 pass through a plurality of the guide rolls 14 until the hollow fiber membranes 102 are accepted by the first nip roll pair 16, and accordingly, the gap between the plurality of hollow fiber membranes 102 is gradually decreased, and the hollow fiber membranes 102 are aligned to be a hollow fiber membrane bundle 104 of a sheet state.

By driving the drive roll 16a of the first nip roll pair 16 to rotate, the hollow fiber membrane bundle 104, which is formed as the plurality of the hollow fiber membranes 102 pass through the plurality of the guide rolls 14 and are aligned, of a length set in advance is accepted.

At this time, it is preferable that a tensile force applied to the hollow fiber membrane 102 present between the drive roll 12 and the first nip roll pair 16 is a tensile force for which the hollow fiber membranes 102 are not stretched above an allowed range described below. In this way, unbalance in the lengths of the hollow fiber membranes 102 of the hollow fiber membrane sheet 100 is small.

Allowed Range: an allowed range of a difference between the length of a longest hollow fiber membrane 102 and the length of a shortest hollow fiber membrane 102 in the hollow fiber membrane sheet 100

By driving the drive roll 18a of the second nip roll pair 18 to rotate, the hollow fiber membrane bundle 104 of a sheet state that is accepted by the first nip roll pair 16 is further accepted. Accordingly, the hollow fiber membrane bundle 104 of the sheet state between the first nip roll pair 16 and the second nip roll pair 18 is in a stretched state, and it is suppressed that entering hollow fiber membranes 102 in which unbalance in the gap between the hollow fiber membranes 102 of the hollow fiber membrane bundle 104 occurs become loose to cause unbalance in the lengths of the hollow fiber membranes 102.

By driving the drive roll 24a of the belt conveyer 24 to rotate, the hollow fiber membrane sheet 100 acquired by cutting the hollow fiber membrane bundle 104 in the cutting step (S3) of the previous time is discharged to the outside of the manufacturing apparatus 1 without staying near the ultrasonic cutter 22.

Fixing Step (S2) and Cutting Step (S3)

FIG. 3 is a schematic diagram that illustrates the fixing step (S2) and the cutting step (S3) according to the first embodiment of the invention.

After the hollow fiber membrane bundle 104 of the length set in advance is accepted by the first nip roll pair 16 and the second nip roll pair 18, the rotation drive of the drive roll 12, the drive roll 16a of the first nip roll pair 16, the drive roll 18a of the second nip roll pair 18, and the drive roll 24a of the belt conveyer 24 is stopped.

When the impulse heater 20 is operated, the hollow fiber membrane bundle 104 is interposed between the crimping lever 20a and the seal receiving base 20b, and the surface of the hollow fiber membranes 102 are melted by the heater disposed in the seal receiving base 20b. Accordingly, the hollow fiber membranes 102 are welded in the widthwise direction of the hollow fiber membrane bundle 104, and fixing parts 106 of two places which have a slight gap at which the hollow fiber membranes 102 are fixed in the widthwise direction of the hollow fiber membrane bundle 104 are formed.

At this time, the hollow fiber membrane bundle 104 of the sheet state between the first nip roll pair 16 and the second nip roll pair 18 is in the stretched state. For this reason, by arranging the impulse heater 20 between the first nip roll pair 16 and the second nip roll pair 18, the fixing parts 106 can be formed in a state in which unbalance in the gap between the hollow fiber membranes 102 of the hollow fiber membrane bundle 104 and unbalance in the lengths of the hollow fiber membranes 102 are suppressed.

In the accepting step (S1), as the hollow fiber membrane bundle 104 of the length set in advance is accepted by the first nip roll pair 16 and the second nip roll pair 18, in the cutting step (S3), the gap between the fixing parts 106 of the two places formed in the fixing step (S2) of the previous time is precisely positioned right below the ultrasonic cutter 22 arranged to leave a same distance as the length of the hollow fiber membrane sheet 100, which is set in advance, from the impulse heater 20 on a further downstream side in the conveyance direction of the hollow fiber membranes 102 than the impulse heater 20. In this state, by operating the ultrasonic cutter 22, the hollow fiber membrane bundle 104 in the gap between the fixing parts 106 of the two places is cut.

After the formation of the fixing parts 106 of the two places using the impulse heater 20 and the cutting of the hollow fiber membrane bundle 104 in the gap between the fixing parts 106 of the two places using the ultrasonic cutter 22 are completed, the accepting step (S1) is started again.

(Action Mechanism)

In the first embodiment described above, by using the first nip roll pair 16 and the second nip roll pair 18, the hollow fiber membrane bundle 104 of the sheet state, in which a plurality of the hollow fiber membranes 102 are aligned, of the length set in advance is accepted, and, after the hollow fiber membrane bundle 104 of the length set in advance is accepted, by using the impulse heater 20, the fixing parts 106 of the two places at which the hollow fiber membranes 102 are fixed in the widthwise direction of the hollow fiber membrane bundle 104 are formed, and the hollow fiber membrane bundle 104 in the gap between the fixing parts 106 of the two places is cut, whereby the structure of the manufacturing apparatus can be simplified. For this reason, the hollow fiber membrane sheet 100 can be manufactured without using a manufacturing apparatus having a complex structure unlike a conventional case.

In addition, the length of the hollow fiber membrane sheet 100 is determined based on the length accepted by the first nip roll pair 16 and the second nip roll pair 18. For this reason, by only controlling the rotation of the first nip roll pair 16 and the second nip roll pair 18, the length of the hollow fiber membrane sheet 100 can be easily changed.

In addition, since the hollow fiber membranes 102 corresponding to a required number are accepted together in the state of the hollow fiber membrane bundle 104 of the sheet state, also in a case where the number of hollow fiber membranes 102 per one hollow fiber membrane sheet 100 is increased, the manufacturing time does not change, whereby the productivity does not decrease.

Furthermore, in the first embodiment described above, since the first nip roll pair 16 and the second nip roll pair 18 are used as the accepting means, the fixing parts 106 can be formed in the stretched state of the hollow fiber membrane bundle 104. For this reason, the fixing parts 106 can be formed in a state in which unbalance in the gap between the hollow fiber membranes 102 of the hollow fiber membrane bundle 104 and unbalance in the lengths of the hollow fiber membranes 102 are suppressed.

In addition, in the first embodiment described above, since the impulse heater 20 is arranged between the first nip roll pair 16 and the second nip roll pair 18, the fixing parts 106 can be formed in a state in which the hollow fiber membrane bundle 104 of the sheet state is stretched between the first nip roll pair 16 and the second nip roll pair 18. For this reason, the fixing parts 106 can be formed in a state in which unbalance in the gap between the hollow fiber membranes 102 of the hollow fiber membrane bundle 104 and unbalance in the lengths of the hollow fiber membranes 102 are suppressed.

In addition, in the first embodiment described above, by using the drive rolls 12, a plurality of the hollow fiber membranes 102 are pulled out from the hollow fiber membrane supplying unit 10, and, by using the first nip roll pair 16 and the second nip roll pair 18, the plurality of the hollow fiber membranes 102 pulled out by the drive rolls 12 are accepted as the hollow fiber membrane bundle 104. Accordingly, a plurality of the hollow fiber membranes 102 do not need to be directly pulled out from the hollow fiber membranes supplying unit 10 by using the first nip roll pair 16 and the second nip roll pair 18. For this reason, since the first nip roll pair 16 and the second nip roll pair 18 may only accept the hollow fiber membrane bundle 104 in synchronization with the conveyance speed of the hollow fiber membranes 102 sent out from the drive rolls 12, a large rotation driving force and large nip pressure are not required. For this reason, deformation and damages in the hollow fiber membranes 102 are suppressed in the first nip roll pair 16 and the second nip roll pair 18.

Furthermore, by arranging the drive rolls 12, a tensile force applied to the hollow fiber membranes 102 between the drive roll 12 and the first nip roll pair 16 can be easily adjusted.

In addition, in the first embodiment described above, in a case where the tensile force applied to the hollow fiber membrane 102 present between the drive roll 12 and the first nip roll pair 16 is set to a tensile force for which the hollow fiber membranes 102 are not stretched above the allowed range described above, unbalance in the lengths of the hollow fiber membranes 102 of the hollow fiber membrane sheet 100 is decreased.

Furthermore, in the first embodiment described above, by using a plurality of the guide rolls 14, a plurality of the hollow fiber membranes 102 are aligned to be the hollow fiber membrane bundle 104 of the sheet state, and accordingly, unbalance in the gap between the hollow fiber membranes 102 of the hollow fiber membrane bundle 104 is suppressed.

In the first embodiment, there are the following problems.
In order to adjust the tensile force applied to the hollow fiber membranes 102 present between the drive roll 12 and the first nip roll pair 16, the tensile force measuring means need to be arranged.
While the tensile force applied to the hollow fiber membranes 102 present between the drive roll 12 and the first nip roll pair 16 is adjusted, a tensile force of a degree forming a stretched state is applied to the hollow fiber membranes 102 present between the drive roll 12 and the first nip roll pair 16. For this reason, in a case where the stretching easiness is different for each hollow fiber membrane, when a plurality of hollow fiber membranes 102 of the length set in advance that are in mutually-different stretched states are accepted and fixed, and then cut, the plurality of hollow fiber membranes 102 released from the stretched states contract to different degrees, and accordingly, unbalance in the lengths of the hollow fiber membranes 102 may easily occur.

Hereinafter, a second embodiment and a third embodiment solving such problems will be described.

### SECOND EMBODIMENT

(Manufacturing Apparatus for Manufacturing Hollow Fiber Membrane Sheet)

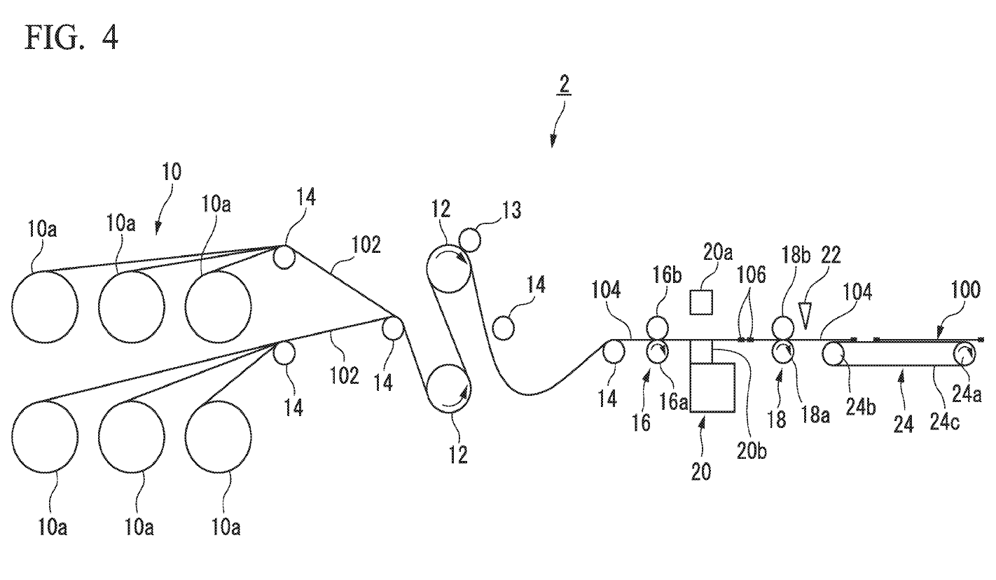

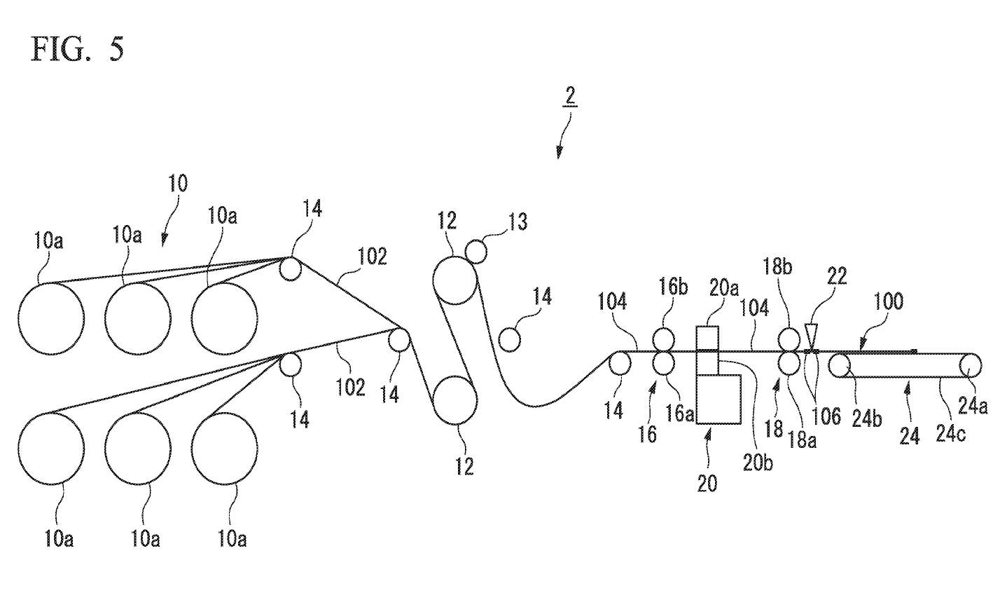

FIGS. 4 and 5 are schematic diagrams that illustrate a manufacturing apparatus for manufacturing a hollow fiber membrane sheet used in the second embodiment of the invention. More specifically, FIG. 4 is a schematic diagram that illustrates an accepting step (S1) according to the second embodiment of the invention, and FIG. 5 is a schematic diagram that illustrates a fixing step (S2) and a cutting step (S3) according to the second embodiment of the invention.

The manufacturing apparatus 2 contains: a hollow fiber membrane supplying unit 10 that stores hollow fiber membranes 102; two drive rolls 12 (pulling-out means), which are vertically arranged in parallel with each other, pulling out a plurality of hollow fiber membranes 102 from the hollow fiber membrane supplying unit 10; a plurality of guide rolls 14 (aligning means), which are arranged on the upstream side and the downstream side in the conveyance direction of the hollow fiber membrane 102 with respect to the drive rolls 12, forming a hollow fiber membrane bundle 104 of a sheet state by aligning a plurality of the hollow fiber membranes 102; a first nip roll pair 16 (accepting means) that accepts the hollow fiber membrane bundle 104 of a sheet state formed by aligning a plurality of the hollow fiber membranes 102 pulled out by the drive rolls 12 by using the guide rolls 14; a second nip roll pair 18 (accepting means) that further accepts the hollow fiber membrane bundle 104 of a sheet state accepted by the first nip roll pair 16; an impulse heater 20 (fixing means) that forms fixing parts 106 of two places, which are arranged between the first nip roll pair 16 and the second nip roll pair 18, at which the hollow fiber membranes 102 are fixed in the widthwise direction of the hollow fiber membrane bundle 104 with a slight gap being arranged; an ultrasonic cutter 22 (cutting means), which is arranged on a further downstream side in the conveyance direction of the hollow fiber membranes 102 than the second nip roll pair 18, cutting the hollow fiber membrane bundle 104 in the gap between the fixing parts 106 of two places; a belt conveyer 24 (discharging means) that discharges the hollow fiber membrane sheet 100 acquired by cutting the hollow fiber membrane bundle 104 by using the ultrasonic cutter 22 to the outside of the manufacturing apparatus 1; and a control means (not illustrated in the drawing) that accepts the hollow fiber membrane bundle 104 of a length set in advance by operating the first nip roll pair 16 and the second nip roll pair 18 so as to accept the hollow fiber membrane bundle 104 of a length set in advance and then stops the first nip roll pair 16 and the second nip roll pair 18 and operates the impulse heater 20 and the ultrasonic cutter 22.

Hereinafter, a same reference numeral will be assigned to a same configuration as that of the first embodiment, and detailed description thereof will not be presented.

Hollow Fiber Membrane Supplying Unit

The hollow fiber membrane supplying unit 10 has the same configuration as that of the first embodiment.

Pulling-Out Means

The drive rolls 12 have the same configuration as those of the first embodiment.

In a case where hollow fiber membranes 102 go up from the peripheral face of the drive roll 12 due to a decrease in the tensile force of the hollow fiber membranes 102 between the drive roll 12 disposed on a latter stage and the first nip roll pair 16, in order to stably convey the hollow fiber membranes 102, a free roll 13 may be arranged so as to lightly hold the hollow fiber membranes 102 between the free roll 13 and the drive roll 12 disposed on the latter stage.

The free roll 13 does not need to be in complete contact with the hollow fiber membranes 102 but may be separated from the drive roll 12 such that the hollow fiber membranes 102 are not disengaged from the grooves of the drive roll 12. In addition, in a range in which the hollow fiber membranes 102 are not damaged, instead of the free roll 13, a bar that cannot be rotated may be arranged.

Aligning Means

A plurality of the guide rolls 14 have the same configuration as that of the first embodiment.

In a case where the hollow fiber membranes 102 present from the drive roll 12 to the first nip roll pair 16 is loosened much, there are also cases where a guide roll 14 not in contact with the hollow fiber membranes 102 is present.

Accepting Means

The first nip roll pair 16 and the second nip roll pair 18 have the same configurations as those of the first embodiment.

Fixing Means

The impulse heater 20 has the same configuration as that of the first embodiment.

Cutting Means

The ultrasonic cutter 22 has the same configuration as that of the first embodiment.

Discharging Means

The belt conveyer 24 has the same configuration as that of the first embodiment.

Control Means

By controlling the first nip roll pair 16, the second nip roll pair 18, the impulse heater 20, and the ultrasonic cutter 22, the control means (not illustrated in the drawing) causes the first nip roll pair 16 and the second nip roll pair 18 to accept the hollow fiber membrane bundle 104 for a length set in advance, and thereafter, by operating the impulse heater 20 and the ultrasonic cutter 22 in the state in which the first nip roll pair 16 and the second nip roll pair 18 are stopped, forms fixing parts 106 of two places in the hollow fiber membrane bundle 104 using the impulse heater 20 and, simultaneously, cuts the hollow fiber membrane bundle 104 in the gap between the fixing parts 106 of two places formed in the fixing step (S2) of the previous time by using the ultrasonic cutter 22.

In addition, the control means controls the rotation speeds of the drive rolls 12 and the first nip roll pair 16 such that a length of the hollow fiber membranes 102 present from the drive roll 12 disposed on the latter stage to the first nip roll pair 16 is longer than a shortest distance of an actual passage from the drive roll 12 disposed on the latter stage to the first nip roll pair 16 by 1 mm or more (preferably 5 mm or more, more preferably 10 mm or more, further more preferably 50 mm or more, and particularly preferably, 100 mm or more). By controlling as such, unbalance in the lengths of the hollow fiber membranes 102 of the hollow fiber membrane sheet 100 is small. An upper limit value of the increased length is preferably, 50 mm or less, is more preferably, 100 mm or less, and is furthermore preferably, 500 mm or less from a point that the loosened hollow fiber membrane 102 is not in contact with the floor and any other roll and is not entangled with any other hollow fiber membrane 102.

The control means contains a processing unit (not illustrated in the drawing), an interface unit (not illustrated in the drawings), and a storage unit (not illustrated in the drawings).

The interface unit electrically connects the rotation drive source of the drive rolls 12, the rotation drive source of the drive roll 16a of the first nip roll pair 16, the rotation drive source of the drive roll 18a of the second nip roll pair 18, the impulse heater 20, the ultrasonic cutter 22, and the rotation drive source of the drive roll 24a of the belt conveyer 24, and the processing unit.

The processing unit controls each means based on settings (the length of the hollow fiber membrane sheet 100 that is set in advance, the rotation speed of each drive roll, the operation times of the impulse heater 20 and the ultrasonic cutter 22, and the like) and the like stored in the storage unit.

In addition, the processing unit may be realized by dedicated hardware. Furthermore, the processing unit may be configured by a memory and a central processing unit (CPU) and realize the function by loading a program used for realizing the function of the processing unit into a memory and executing the program.

An input device, a display device, and the like as peripheral devices are connected to the control means.

(Method of Manufacturing Hollow Fiber Membrane Sheet)

Hereinafter, a method of manufacturing a hollow fiber membrane sheet according to the second embodiment of the invention using the manufacturing apparatus 2 will be described with reference to the drawings.

The method of manufacturing a hollow fiber membrane sheet according to the second embodiment of the invention includes an accepting step (S1) to be described below, a fixing step (S2) to be described below, and a cutting step (S3) to be described below.

(S1) a step of pulling out a plurality of hollow fiber membranes 102 from the hollow fiber membrane supplying unit 10 by using the drive rolls 12, aligning the plurality of hollow fiber membranes 102 that have been pulled out to be a hollow fiber membrane bundle 104 of a sheet state by using a plurality of the guide rolls 14, and accepting the hollow fiber membrane bundle 104 by using the first nip roll pair 16 and the second nip roll pair 18

(S2) a step of, after accepting the hollow fiber membrane bundle 104 for a length set in advance, forming fixing parts 106 of two places at which the hollow fiber membranes 102 are fixed in the widthwise direction of the hollow fiber membrane bundle 104 by using the impulse heater 20 in a state in which the drive rolls 12, the first nip roll pair 16 and the second nip roll pair 18 are stopped

(S3) a step of cutting the hollow fiber membrane bundle 104 in the gap between the fixing parts 106 of two places by using the ultrasonic cutter 22

In the second embodiment, in the cutting step (S3), the gap between the fixing parts 106 of two places formed in the fixing step (S2) of the previous time are cut, and, a series of flows of simultaneously performing the fixing step (S2) and the cutting step (S3) after performing the accepting step (S1) is repeatedly performed.

Hereinafter, operations and preferred forms that are the same as those of the first embodiment will not be described in detail.

Accepting Step (S1)

FIG. 4 is a schematic diagram that illustrates the accepting step (S1) according to the second embodiment of the invention.

According to the second embodiment, a length of the hollow fiber membranes 102 present from the drive roll 12 disposed on the latter stage to the first nip roll pair 16 is configured to be longer than a shortest distance of an actual passage from the drive roll 12 disposed on the latter stage to the first nip roll pair 16 by 1 mm or more (preferably 5 mm or more, more preferably 10 mm or more, further more preferably 50 mm or more, and particularly preferably, 100 mm or more). Accordingly, unbalance in the lengths of the hollow fiber membranes 102 of the hollow fiber membrane sheet 100 is small. An upper limit value of the increased length is preferably, 50 mm or less, is more preferably, 100 mm or less, and is furthermore preferably, 500 mm or less from a point that the loosened hollow fiber membrane 102 is not in contact with the floor and any other roll and is not entangled with any other hollow fiber membrane 102.

The accepting step (S1) is the same as that of the first embodiment except that the length of the hollow fiber membranes 102 present from the drive roll 12 disposed on the latter stage to the first nip roll pair 16 is configured to be longer than the shortest distance of the actual passage from the drive roll 12 disposed on the latter stage to the first nip roll pair 16 by 1 mm or more

Fixing Step (S2) and Cutting Step (S3)

FIG. 5 is a schematic diagram that illustrates the fixing step (S2) and the cutting step (S3) according to the second embodiment of the invention.

The fixing step (S2) and the cutting step (S3) are the same as those of the first embodiment.

(Action Mechanism)

In the second embodiment described above, by using the first nip roll pair 16 and the second nip roll pair 18, the hollow fiber membrane bundle 104 of the sheet state, in which a plurality of the hollow fiber membranes 102 are aligned, of the length set in advance is accepted, and, after the hollow fiber membrane bundle 104 of the length set in advance is accepted, by using the impulse heater 20, the fixing parts 106 of the two places at which the hollow fiber membranes 102 are fixed in the widthwise direction of the hollow fiber membrane bundle 104 are formed, and the hollow fiber membrane bundle 104 in the gap between the fixing parts 106 of the two places is cut, whereby the structure of the manufacturing apparatus can be simplified. For this reason, the hollow fiber membrane sheet 100 can be manufactured without using a manufacturing apparatus having a complex structure unlike a conventional case.

In addition, the length of the hollow fiber membrane sheet 100 is determined based on the length accepted by the first nip roll pair 16 and the second nip roll pair 18. For this reason, by only controlling the rotation of the first nip roll pair 16 and the second nip roll pair 18, the length of the hollow fiber membrane sheet 100 can be easily changed.

In addition, since the hollow fiber membranes 102 corresponding to a required number are accepted together in the state of the hollow fiber membrane bundle 104 of the sheet state, also in a case where the number of hollow fiber membranes 102 per one hollow fiber membrane sheet 100 is increased, the manufacturing time does not change, whereby the productivity does not decrease.

Furthermore, in the second embodiment described above, since the first nip roll pair 16 and the second nip roll pair 18 are used as the accepting means, the fixing parts 106 can be formed in the stretched state of the hollow fiber membrane bundle 104 of a sheet state between the first nip roll pair 16 and the second nip roll pair 18. For this reason, the fixing parts 106 can be formed in a state in which unbalance in the gap between the hollow fiber membranes 102 of the hollow fiber membrane bundle 104 and unbalance in the lengths of the hollow fiber membranes 102 are suppressed.

In addition, in the second embodiment described above, since the impulse heater 20 is arranged between the first nip roll pair 16 and the second nip roll pair 18, the fixing parts 106 can be formed in a state in which the hollow fiber membrane bundle 104 of the sheet state is stretched between the first nip roll pair 16 and the second nip roll pair 18. For this reason, the fixing parts 106 can be formed in a state in which unbalance in the gap between the hollow fiber membranes 102 of the hollow fiber membrane bundle 104 and unbalance in the lengths of the hollow fiber membranes 102 are suppressed.

In addition, in the second embodiment described above, by using the drive rolls 12, a plurality of the hollow fiber membranes 102 are pulled out from the hollow fiber membrane supplying unit 10, and, by using the first nip roll pair 16 and the second nip roll pair 18, the plurality of the hollow fiber membranes 102 pulled out by the drive rolls 12 are accepted as the hollow fiber membrane bundle 104. Accordingly, a plurality of the hollow fiber membranes 102 do not need to be directly pulled out from the hollow fiber membranes supplying unit 10 by using the first nip roll pair 16 and the second nip roll pair 18. For this reason, since the first nip roll pair 16 and the second nip roll pair 18 may only accept the hollow fiber membrane bundle 104 in synchronization with the conveyance speed of the hollow fiber membranes 102 sent out from the drive rolls 12, a large rotation driving force and large nip pressure are not required. For this reason, deformation and damages in the hollow fiber membranes 102 are suppressed in the first nip roll pair 16 and the second nip roll pair 18.

Furthermore, by arranging the drive rolls 12, the length of the hollow fiber membranes 102 between the drive roll 12 and the first nip roll pair 16 can be easily adjusted.

According to the second embodiment described above, the length of the hollow fiber membranes 102 present from the drive roll 12 disposed on the latter stage to the first nip roll pair 16 is configured to be longer than the shortest distance of an actual passage from the drive roll 12 disposed on the latter stage to the first nip roll pair 16 by 1 mm or more. For this reason, a tensile force is hardly applied to the hollow fiber membranes 102, and a plurality of the hollow fiber membranes 102 of a length set in advance are accepted in a non-stretched state. For this reason, when the plurality of the hollow fiber membranes 102 are fixed and then cut, the plurality of the hollow fiber membranes 102 hardly contract. For this reason, unbalance in the lengths of the hollow fiber membranes 102 of the hollow fiber membrane sheet 100 is small.

In addition, since the tensile force applied to the hollow fiber membranes 102 present between the drive roll 12 and the first nip roll pair 16 does not need to be adjusted, the tensile force measuring means is not necessary.

Furthermore, in the second embodiment described above, by using a plurality of the guide rolls 14, a plurality of the hollow fiber membranes 102 are aligned to be the hollow fiber membrane bundle 104 of the sheet state, and accordingly, unbalance in the gap between the hollow fiber membranes 102 of the hollow fiber membrane bundle 104 is suppressed.

In the second embodiment, there are the following problems.
The tensile force applied to a hollow fiber membrane 102 between the hollow fiber membrane supplying unit 10 and the drive roll 12 is slightly different for each hollow fiber membrane 102 based on the winding quantity of each bobbin 10a supplying the hollow fiber membrane 102, the brake strength of each bobbin 10a, and the like. For this reason, the conveyance speed of the hollow fiber membrane 102 sent out from the drive roll 12 is slightly different for each hollow fiber membrane 102. For this reason, by repeatedly performing a series of flows of simultaneously performing the fixing step (S2) and the cutting step (S3) after performing the accepting step (S1), gradually, the length of a hollow fiber membrane 102 present from drive roll 12 disposed on the latter stage to the first nip roll pair 16 is different much for each of the hollow fiber membranes 102. In such a case, the manufacturing process is stopped once, and an operation of aligning the lengths of the hollow fiber membranes 102 presented from the drive roll 12 disposed on the latter stage to the first nip roll pair 16 is required.

Hereinafter, a third embodiment solving such problems will be described.

### THIRD EMBODIMENT

(Manufacturing Apparatus for Hollow Fiber Membrane Sheet)

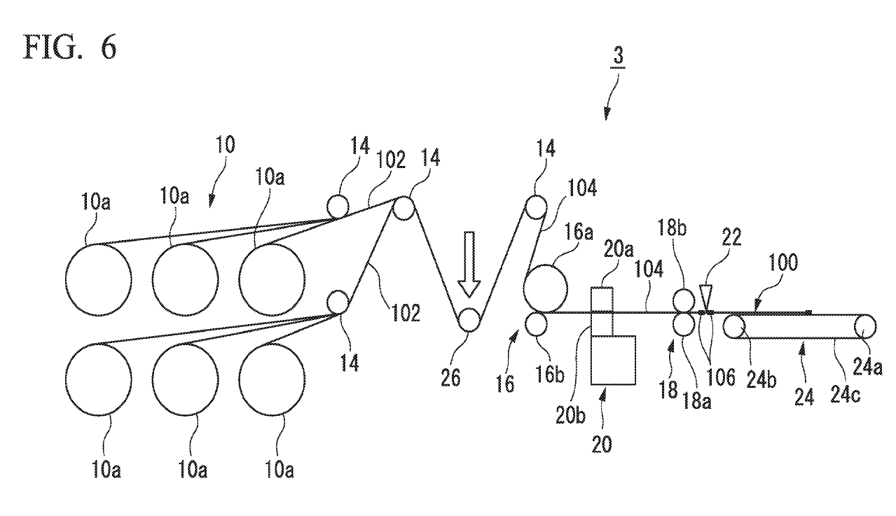

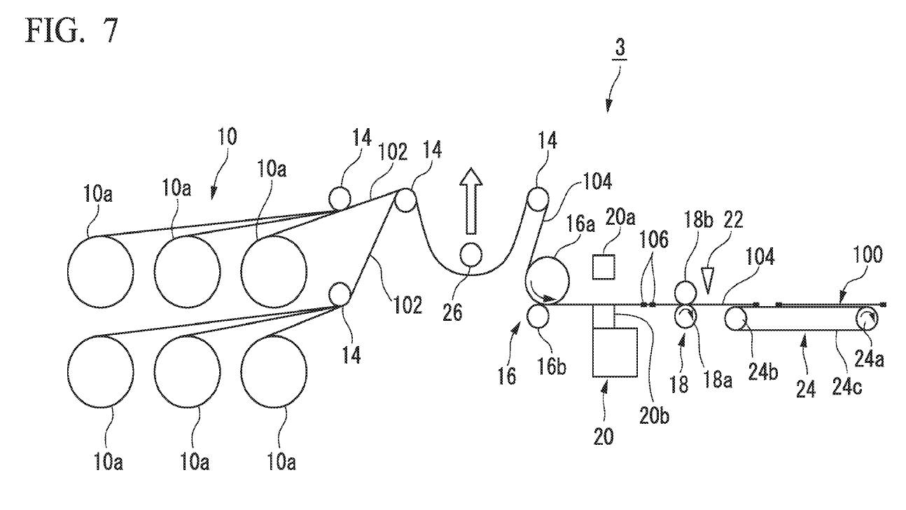

FIGS. 6 and 7 are schematic diagrams that illustrate a manufacturing apparatus for manufacturing a hollow fiber membrane sheet used in the third embodiment of the invention. More specifically, FIG. 6 is a schematic diagram that illustrates a fixing step (S2) and a cutting step (S3) according to the third embodiment of the invention, and FIG. 7 is a schematic diagram that illustrates a pulling-out step (S1) according to the third embodiment of the invention.

The manufacturing apparatus 3 contains: a hollow fiber membrane supplying unit 10 that stores hollow fiber membranes 102; a movable roll 26 (pulling-out means), which are movable in the vertical direction between two guide rolls 14, pulling out a plurality of hollow fiber membranes 102 from the hollow fiber membrane supplying unit 10; a plurality of guide rolls 14 (aligning means), which are arranged on the upstream side and the downstream side in the conveyance direction of the hollow fiber membrane 102 with respect to the movable roll 26, forming a hollow fiber membrane bundle 104 of a sheet state by aligning a plurality of the hollow fiber membranes 102; a first nip roll pair 16 (accepting means) that accepts the hollow fiber membrane bundle 104 of a sheet state formed by aligning a plurality of the hollow fiber membranes 102 pulled out by the movable roll 26 by using the guide rolls 14; a second nip roll pair 18 (accepting means) that further accepts the hollow fiber membrane bundle 104 of a sheet state accepted by the first nip roll pair 16; an impulse heater 20 (fixing means) that forms fixing parts 106 of two places, which are arranged between the first nip roll pair 16 and the second nip roll pair 18, at which the hollow fiber membranes 102 are fixed in the widthwise direction of the hollow fiber membrane bundle 104 with a slight gap being arranged; an ultrasonic cutter 22 (cutting means), which is arranged on a further downstream side in the conveyance direction of the hollow fiber membranes 102 than the second nip roll pair 18, cutting the hollow fiber membrane bundle 104 in the gap between the fixing parts 106 of two places; a belt conveyer 24 (discharging means) that discharges the hollow fiber membrane sheet 100 acquired by cutting the hollow fiber membrane bundle 104 by using the ultrasonic cutter 22 to the outside of the manufacturing apparatus 1; and a control means (not illustrated in the drawing) that accepts the hollow fiber membrane bundle 104 of a length set in advance by operating the first nip roll pair 16 and the second nip roll pair 18 so as to accept the hollow fiber membrane bundle 104 of a length set in advance and then stops the first nip roll pair 16 and the second nip roll pair 18 and operates the impulse heater 20 and the ultrasonic cutter 22.

Hereinafter, a same reference numeral will be assigned to a same configuration as that of the first embodiment, and detailed description thereof will not be presented.

Hollow Fiber Membrane Supplying Unit

The hollow fiber membrane supplying unit 10 has the same configuration as that of the first embodiment.

Pulling-Out Means

The movable roll 26 is configured to be movable in the vertical direction by a guide rail (moving means) (not illustrated in the drawing) extending in the vertical direction.

The movable roll 26 pulls out a plurality of hollow fiber membranes 102 from the hollow fiber membrane supplying unit 10 by moving the movable roll 26 to the lower side so as to push down the hollow fiber membranes 102 stretched over between the guide rolls 14 before and after the movable roll 26.

Aligning Means

A plurality of the guide rolls 14 have the same configuration as that of the first embodiment.

The guide rolls 14 before and after the movable roll 26 are arranged at an almost same height.

Accepting Means

The first nip roll pair 16 and the second nip roll pair 18 have the same configurations as those of the first embodiment.

Fixing Means

The impulse heater 20 has the same configuration as that of the first embodiment.

Cutting Means

The ultrasonic cutter 22 has the same configuration as that of the first embodiment.

Discharging Means

The belt conveyer 24 has the same configuration as that of the first embodiment.

Control Means

By controlling the first nip roll pair 16, the second nip roll pair 18, the impulse heater 20, and the ultrasonic cutter 22, the control means (not illustrated in the drawing) causes the first nip roll pair 16 and the second nip roll pair 18 to accept the hollow fiber membrane bundle 104 for a length set in advance, and thereafter, by operating the impulse heater 20 and the ultrasonic cutter 22 in the state in which the first nip roll pair 16 and the second nip roll pair 18 are stopped, forms fixing parts 106 of two places in the hollow fiber membrane bundle 104 using the impulse heater 20 and, simultaneously, cuts the hollow fiber membrane bundle 104 in the gap between the fixing parts 106 of two places formed in the fixing step (S2) of the previous time by using the ultrasonic cutter 22.

In addition, while the first nip roll pair 16 and the second nip roll pair 18 are stopped, until a length of the hollow fiber membranes 102 present between the guide rolls 14 becomes longer than a distance between the guide rolls 14 before and after the movable roll 26 by a length, which is set in advance, accepted by the first nip roll pair 16 or more, the control means moves the movable roll 26 to the lower side so as to push down the hollow fiber membrane 102 stretched over between the two guide rolls 14 and saves the movable roll 26 to the upper side of the hollow fiber membrane 102 so as not to be in contact with the hollow fiber membrane 102 while the first nip roll pair 16 and the second nip roll pair 18 are operated.

An upper limit value of the increased length is preferably, 50 mm longer than the length set in advance that is accepted by the first nip roll pair 16 or less, is more preferably, 100 mm longer than the length or less, and is furthermore preferably, 500 mm longer than the length or less from a point that the loosened hollow fiber membrane 102 is not in contact with the floor and any other roll and is not entangled with any other hollow fiber membrane 102.

The control means contains a processing unit (not illustrated in the drawing), an interface unit (not illustrated in the drawings), and a storage unit (not illustrated in the drawings).

The interface unit electrically connects a moving means of the movable roll 26, the rotation drive source of the drive rolls 12, the rotation drive source of the drive roll 16a of the first nip roll pair 16, the rotation drive source of the drive roll 18a of the second nip roll pair 18, the impulse heater 20, the ultrasonic cutter 22, and the rotation drive source of the drive roll 24a of the belt conveyer 24 and the processing unit.

The processing unit controls each means based on settings (the movement distance of the movable roll 26, the length of the hollow fiber membrane sheet 100 that is set in advance, the rotation speed of each drive roll, the operation times of the impulse heater 20 and the ultrasonic cutter 22, and the like) and the like stored in the storage unit.

In addition, the processing unit may be realized by dedicated hardware. Furthermore, the processing unit may be configured by a memory and a central processing unit (CPU) and realize the function by loading a program used for realizing the function of the processing unit into a memory and executing the program.

An input device, a display device, and the like as peripheral devices are connected to the control means.

(Method of Manufacturing Hollow Fiber Membrane Sheet)

Hereinafter, a method of manufacturing a hollow fiber membrane sheet according to the third embodiment of the invention using the manufacturing apparatus 3 will be described with reference to the drawings.

The method of manufacturing a hollow fiber membrane sheet according to the third embodiment of the invention includes an accepting step (S1) to be described below, a fixing step (S2) to be described below, a cutting step (S3) to be described below, and a pulling-out step (S4) to be described below.

(S1) after a plurality of hollow fiber membranes 102 of a length set in advance or more are pulled out from the hollow fiber membrane supplying unit 10 in the pulling-out step (S4) to be described later, a step of accepting a hollow fiber membrane bundle 104 of a sheet state in which a plurality of hollow fiber membranes 102 are aligned by a plurality of guide rolls 14 by using the first nip roll pair 16 and the second nip roll pair 18

(S2) a step of, after accepting the hollow fiber membrane bundle 104 for a length set in advance, forming fixing parts 106 of two places at which the hollow fiber membranes 102 are fixed in the widthwise direction of the hollow fiber membrane bundle 104 by using the impulse heater 20 in a state in which the drive rolls 12, the first nip roll pair 16 and the second nip roll pair 18 are stopped

(S3) a step of cutting the hollow fiber membrane bundle 104 in the gap between the fixing parts 106 of two places by using the ultrasonic cutter 22

(S4) before the accepting step (S1), a step of pulling out a plurality of hollow fiber membranes 102 of a length set in advance or more from the hollow fiber membrane supplying unit 10 by pushing down the hollow fiber membranes 102 stretched over between the two guide rolls 14 by using the movable roll 26

In the third embodiment, in the cutting step (S3), the gap between the fixing parts 106 of two places formed in the fixing step (S2) of the previous time are cut, and, a series of flows of simultaneously performing the fixing step (S2), the cutting step (S3), and the pulling-out step (S4) after performing the accepting step (S1) is repeatedly performed.

Hereinafter, operations and preferred forms that are the same as those of the first embodiment will not be described in detail.

Pulling-Out Step (S4)

FIG. 6 is a schematic diagram that illustrates the fixing step (S2), the cutting step (S3), and the pulling-out step (S4) according to the third embodiment of the invention.

In a state in which the rotation drive of the drive roll 16a of the first nip roll pair 16, the drive roll 18a of the second nip roll pair 18, and the drive roll 24a of the belt conveyer 24 is stopped, by pushing down the hollow fiber membrane 102 stretched over between the guide rolls 14 before and after the movable roll 26 using the movable roll 26, the length of the hollow fiber membrane 102 present between the guide rolls 14 becomes longer than the distance between the guide rolls 14 before and after the movable roll 26 by a length set in advance that is accepted by the first nip roll pair 16 (more preferably, 1 mm or more than the length set in advance, more preferably, 5 mm or more than the length, further more preferably, 10 mm or more than the length, particularly preferably, 50 mm or more, and the most preferably, 100 mm or more).

An upper limit value of the increased length is preferably, 50 mm longer than the length set in advance that is accepted by the first nip roll pair 16 or less, is more preferably, 100 mm longer than the length or less, and is furthermore preferably, 500 mm longer than the length or less from a point that the loosened hollow fiber membrane 102 is not in contact with the floor and any other roll and is not entangled with any other hollow fiber membrane 102.

When the pulling-out step (S4) is performed, the fixing step (S2) and the cutting step (S3) to be described later are simultaneously performed.

Accepting Step (S1)

FIG. 7 is a schematic diagram that illustrates the accepting step (S1) according to the third embodiment.

A plurality of hollow fiber membranes 102 pulled out from the hollow fiber membrane supplying unit 10 in the pulling-out step (S4) pass through a plurality of the guide rolls 14 until the hollow fiber membranes 102 are accepted by the first nip roll pair 16, and accordingly, the gap between the plurality of hollow fiber membranes 102 is gradually decreased, and the hollow fiber membranes 102 are aligned to be a hollow fiber membrane bundle 104 of a sheet state.

By driving the drive roll 16a of the first nip roll pair 16 to rotate, the hollow fiber membrane bundle 104, which is formed as the plurality of the hollow fiber membranes 102 pass through the plurality of the guide rolls 14 and are aligned, of a length set in advance is accepted.

At this time, the hollow fiber membrane 102 present between the guide rolls 14 before and after the movable roll 26 goes up. Accordingly, by saving the movable roll 26 to the upper side of the hollow fiber membrane 102 so as not to be in contact with the hollow fiber membrane 102, the movable roll 26 does not interrupt the going-up of the hollow fiber membrane 102, and an extra tensile force is not applied to the hollow fiber membrane 102. The movable roll 26 may be disposed to the upper side of the hollow fiber membrane 102 that is disposed right below the movable roll 26, and the movable roll 26 may be raised in synchronization with the rising speed of the hollow fiber membrane 102 in a state in which the movable roll 26 is in contact with the hollow fiber membrane 102.

By driving the drive roll 18a of the second nip roll pair 18 to rotate, the hollow fiber membrane bundle 104 of a sheet state that is accepted by the first nip roll pair 16 is further accepted. Accordingly, the hollow fiber membrane bundle 104 of the sheet state between the first nip roll pair 16 and the second nip roll pair 18 is in a stretched state, and it is suppressed that entering hollow fiber membranes 102 in which unbalance in the gap between the hollow fiber membranes 102 of the hollow fiber membrane bundle 104 occurs become loose to cause unbalance in the lengths of the hollow fiber membranes 102.

By driving the drive roll 24a of the belt conveyer 24 to rotate, the hollow fiber membrane sheet 100 acquired by cutting the hollow fiber membrane bundle 104 in the cutting step (S3) of the previous time is discharged to the outside of the manufacturing apparatus 1 without staying near the ultrasonic cutter 22.

Fixing Step (S2) and Cutting Step (S3)

The fixing step (S2) and the cutting step (S3) are the same as those of the first embodiment.

(Action Mechanism)

In the third embodiment described above, by using the first nip roll pair 16 and the second nip roll pair 18, the hollow fiber membrane bundle 104 of the sheet state, in which a plurality of the hollow fiber membranes 102 are aligned, of the length set in advance is accepted, and, after the hollow fiber membrane bundle 104 of the length set in advance is accepted, by using the impulse heater 20, the fixing parts 106 of the two places at which the hollow fiber membranes 102 are fixed in the widthwise direction of the hollow fiber membrane bundle 104 are formed, and the hollow fiber membrane bundle 104 in the gap between the fixing parts 106 of the two places is cut, whereby the structure of the manufacturing apparatus can be simplified. For this reason, the hollow fiber membrane sheet 100 can be manufactured without using a manufacturing apparatus having a complex structure unlike a conventional case.

In addition, the length of the hollow fiber membrane sheet 100 is determined based on the length accepted by the first nip roll pair 16 and the second nip roll pair 18. For this reason, by only controlling the rotation of the first nip roll pair 16 and the second nip roll pair 18, the length of the hollow fiber membrane sheet 100 can be easily changed.

In addition, since the hollow fiber membranes 102 corresponding to a required number are accepted together in the state of the hollow fiber membrane bundle 104 of the sheet state, also in a case where the number of hollow fiber membranes 102 per one hollow fiber membrane sheet 100 is increased, the manufacturing time does not change, whereby the productivity does not decrease.

Furthermore, in the third embodiment described above, since the first nip roll pair 16 and the second nip roll pair 18 are used as the accepting means, the fixing parts 106 can be formed in a state in which unbalance in the gap between the hollow fiber membranes 102 of the hollow fiber membrane bundle 104 and unbalance in the lengths of the hollow fiber membranes 102 are suppressed.

In addition, in the third embodiment described above, since the impulse heater 20 is arranged between the first nip roll pair 16 and the second nip roll pair 18, the fixing parts 106 can be formed in a state in which the hollow fiber membrane bundle 104 of the sheet state is stretched between the first nip roll pair 16 and the second nip roll pair 18. For this reason, the fixing parts 106 can be formed in a state in which unbalance in the gap between the hollow fiber membranes 102 of the hollow fiber membrane bundle 104 and unbalance in the lengths of the hollow fiber membranes 102 are suppressed.

In addition, in the third embodiment described above, by using the movable roll 26, a plurality of the hollow fiber membranes 102 are pulled out from the hollow fiber membrane supplying unit 10, and, by using the first nip roll pair 16 and the second nip roll pair 18, the plurality of the hollow fiber membranes 102 pulled out by the movable roll 26 are accepted as the hollow fiber membrane bundle 104. Accordingly, a plurality of the hollow fiber membranes 102 do not need to be directly pulled out from the hollow fiber membranes supplying unit 10 by using the first nip roll pair 16 and the second nip roll pair 18. For this reason, since the first nip roll pair 16 and the second nip roll pair 18 may only accept the hollow fiber membrane bundle 104 formed by the hollow fiber membranes 102 that have already been sent out by the movable roll 26, a large rotation driving force and large nip pressure are not required. For this reason, deformation and damages in the hollow fiber membranes 102 are suppressed in the first nip roll pair 16 and the second nip roll pair 18.

Furthermore, in the third embodiment described above, before the accepting step (S1), by pushing down the hollow fiber membrane 102 stretched over between the two guide rolls 14 by using the movable roll 26, the length of the hollow fiber membrane 102 present between the guide rolls 14 becomes longer than the distance between the guide rolls 14 before and after the movable roll 26 by a length set in advance that is accepted by the first nip roll pair 16. For this reason, at the time of performing the accepting step (S1), a tensile force is hardly applied to the hollow fiber membranes 102, and a plurality of the hollow fiber membranes 102 of a length set in advance are accepted in a non-stretched state. For this reason, unbalance in the lengths of the hollow fiber membranes 102 of the hollow fiber membrane sheet 100 is small.

In addition, in a case where the length of each of the plurality of hollow fiber membranes 102 present between the guide rolls 14 before and after movable roll 26 is different for each hollow fiber membrane 102, at the time of performing the pulling-out step (S4), the hollow fiber membranes are pushed down by the movable roll 26 in order from a shortest hollow fiber membrane 102. For this reason, after performing the accepting step (S1), even in a case where a series of flows of simultaneously performing the fixing step (S2), the cutting step (S3), and the pulling-out step (S4) is repeatedly performed, a difference between the length of the shortest hollow fiber membrane 102 and the length of a longest hollow fiber membrane 102 is not increased. For this reason, an operation of stopping the manufacturing process once and aligning the lengths of the hollow fiber membranes 102 present between the guide rolls 14 before and after the movable roll 26 is not necessary.

In addition, since the tensile force applied to the hollow fiber membranes 102 present on a further upstream side in the conveyance direction of the hollow fiber membrane bundle 104 than the first nip roll pair 16 does not need to be adjusted, the tensile force measuring means is not necessary.

Furthermore, in the third embodiment described above, by using a plurality of the guide rolls 14, a plurality of the hollow fiber membranes 102 are aligned to be a hollow fiber membrane bundle 104 of a sheet state, and accordingly, unbalance in the gaps between the hollow fiber membranes 102 of the hollow fiber membrane bundle 104 is suppressed.

### OTHER EMBODIMENTS

The manufacturing method and the manufacturing apparatus for a hollow fiber membrane sheet according to the invention are not limited to the first embodiment, the second embodiment, and the third embodiment described above.

For example, the hollow fiber membrane supplying unit is not limited to the creel stand in which a bobbin is set but may be a container housing hollow fiber membranes or the like.

In the first embodiment, the pulling-out means may be omitted.

The hollow fiber membrane supplying unit may also have the function of the pulling-out means by driving the bobbin to rotate or the like.

Of the accepting means before and after the fixing means, the function of the accepting means disposed on the upstream side in the conveyance direction of the hollow fiber membrane bundle may be provided as an additional function of the pulling-out means and be omitted.

The accepting means is not limited to the nip roll pair but may be formed by one drive roll.

In the illustrated example, while the fixing parts of two places are formed at once, after formation of a first fixing part, a second fixing part may be formed by slightly moving the hollow fiber membrane bundle or the fixing means. In addition, it may be configured such that a fixing part is formed at one place, and the fixing part is cut by the cutting means.

In the fixing parts, the shape of the hollow fiber membranes (hollow shape) does not need to be maintained.

The fixing means is not limited to the impulse heater. For example, the fixing means may be an ultrasonic welding machine, a heat fusion machine other than the impulse heater, an adhesive tape supplying device, an adhesive resin coating machine, a knitting machine, a jig supplying device, or the like.

The cutting means is not limited to the ultrasonic cutter. For example, the cutting means may be a cutter, scissors, a rotary knife, a heater wire, a laser cutter, or the like. In addition, the cutting operation may be manually performed.

A cutting plane line used at the time of performing cutting using the cutting means does not need to be a straight line.

The discharging means is not limited to the belt conveyer. For example, in a case where the discharging means can be arranged with an inclination, a gravity conveyer or the like may be used. In addition, the discharging means may be a mechanical hand. Furthermore, the discharging means may be omitted.

### EXAMPLE

Hereinafter, the invention will be described more specifically using examples. However, the invention is not limited thereto.

### Example 1

Hollow fiber membrane sheets 100 were manufactured using the manufacturing apparatus 1 according to the first embodiment illustrated in FIGS. 2 and 3.

As the hollow fiber membranes 102, hollow fiber membranes (Breed: ADF2800CA-1, Material: PVDF, Outer diameter: 2.8 mm) manufactured by Mitsubishi Rayon Co., Ltd. were used.

A bobbin 10a around which the hollow fiber membranes 102 were wound was set in a creel stand having a creel 6 spindle.

Six hollow fiber membranes 102 wound from the creel stand were arranged at a gap of 3.2 mm through a guide roll 14 and were brought into contact with a drive roll 12.

As the drive rolls 12, metal rolls (outer diameter: 250 mm) of which the peripheral faces were finished in a mirror surface shape were used. Two drive rolls 12 were configured to be synchronously rotated at an equal speed by delivering the rotation of a drive motor to rotation shafts of the drive rolls 12 through a timing belt.

As each of the rolls of the first nip roll pair 16 and the second nip roll pair 18, a rubber lining roll (outer diameter: 80 mm) was used. The drive roll 16a and the drive roll 18a were configured to be synchronously rotated at an equal speed by delivering the rotation of a drive motor to rotation shafts of the drive roll 16a and the drive roll 18a through a timing belt.

A tensile force applied to the hollow fiber membranes 102 between the creel stand and the first nip roll pair 16 was in the range of 2.45 to 4.9 N.

A target length (a length set in advance) of the hollow fiber membrane sheet 100 was set to 2000 mm.

101 hollow fiber membrane sheets 100 were manufactured by performing the manufacturing method according to the first embodiment described above, in other words, by repeatedly performing a series of flows of simultaneously performing the fixing step (S2) and the cutting step (S3) after performing the accepting step (S1).

For each of the 101 hollow fiber membrane sheets 100, a difference (a longest length a shortest length) between the length of a longest hollow fiber membrane 102 and the length of a shortest hollow fiber membrane 102 was measured, the difference for the hollow fiber membrane sheet 100 in which the difference was largest was 14 mm (0.7% for the length set in advance).

### Example 2

Hollow fiber membrane sheets 100 were manufactured using the manufacturing apparatus 2 according to the second embodiment illustrated in FIGS. 4 and 5.

The condition was the same as that of Example 1 except that a tensile force applied to the hollow fiber membranes 102 between the creel stand and the drive roll 12 disposed on the former stage was in the range of 2.45 to 4.9 N, a length of the hollow fiber membrane 102 present from the drive roll 12 disposed on the latter stage to the first nip roll pair 16 was configured to be longer than a shortest distance of an actual passage from the drive roll 12 disposed on the latter stage to the first nip roll pair 16 by 100 mm or more, and a tensile force is hardly applied to the hollow fiber membrane 102 between the drive roll 12 disposed on the latter stage and the first nip roll pair 16.

101 hollow fiber membrane sheets 100 were manufactured by performing the manufacturing method according to the second embodiment described above, in other words, by repeatedly performing a series of flows of simultaneously performing the fixing step (S2) and the cutting step (S3) after performing the accepting step (S1).

For each of the 101 hollow fiber membrane sheets 100, a difference (a longest length a shortest length) between the length of a longest hollow fiber membrane 102 and the length of a shortest hollow fiber membrane 102 was measured, the difference for the hollow fiber membrane sheet 100 in which the difference is largest was 5 mm (0.25% for the length set in advance).

A length of the hollow fiber membrane 102 present from the drive roll 12 disposed on the latter stage to the first nip roll pair 16 was longer than the shortest distance of the actual passage from the drive roll 12 disposed on the latter stage to the first nip roll pair 16 by 100 mm immediately after manufacturing the first hollow fiber membrane sheet but by 600 mm immediately after manufacturing the 101st hollow fiber membrane sheet.

### Example 3

Hollow fiber membrane sheets 100 were manufactured using the manufacturing apparatus 3 according to the third embodiment illustrated in FIGS. 6 and 7.

As the hollow fiber membranes 102, the same hollow fiber membranes as those of the first embodiment were used.

A bobbin 10a around which the hollow fiber membranes 102 were wound was set in a creel stand having a creel 6 spindle.

Six hollow fiber membranes 102 wound from the creel stand were arranged at a gap of 3.2 mm through a guide roll 14 and were brought into contact with a movable roll 26.

Before the accepting step (S1), by pushing down the hollow fiber membrane 102 stretched over between the two guide rolls 14 by using the movable roll 26, a plurality of hollow fiber membranes 102 were pulled out from the hollow fiber membrane supplying unit 10, and the length of the hollow fiber membrane 102 present between the guide rolls 14 were configured to be longer than the distance between the guide rolls 14 before and after the movable roll 26 by 2500 mm.

As the first nip roll pair 16 and the second nip roll pair 18, the same nip roll pairs as those of the first embodiment were used.

A target length (a length set in advance) of the hollow fiber membrane sheet 100 was set to 2000 mm.

101 hollow fiber membrane sheets 100 were manufactured by performing the manufacturing method according to the third embodiment described above, in other words, by repeatedly performing a series of flows of simultaneously performing the fixing step (S2), the cutting step (S3), and the pulling-out step (S4) after performing the accepting step (S1).

For each of the 101 hollow fiber membrane sheets 100, a difference (a longest length a shortest length) between the length of a longest hollow fiber membrane 102 and the length of a shortest hollow fiber membrane 102 was measured, the difference for the hollow fiber membrane sheet 100 in which the difference was largest was 8 mm (0.4% for the length set in advance).

There was no change in the length of the hollow fiber membrane 102 present between the guide rolls 14 with respect to the distance between the guide rolls 14 before and after the movable roll 26 immediately after the manufacturing the first hollow fiber membrane sheet and immediately after manufacturing the 101st hollow fiber membrane sheet.

### INDUSTRIAL APPLICABILITY

A hollow fiber membrane sheet acquired using a manufacturing method according to the invention is useful as a member of a hollow fiber membrane module used for manufacturing sterile water, beverages, or high-degree pure water, purification of the air, a drainage process, and the like.

### EXPLANATIONS OF LETTERS OR NUMERALS

1 manufacturing apparatus
2 manufacturing apparatus
3 manufacturing apparatus
10 hollow fiber membrane supplying unit
10a bobbin
12 drive roll
13 free roll
14 guide roll
16 first nip roll pair
16a drive roll
16b free roll
18 second nip roll pair
18a drive roll
18b free roll
20 impulse heater
20a crimping lever
20b seal receiving base
22 ultrasonic cutter
24 belt conveyer
24a drive roll
24b free roll
24c endless belt
26 movable roll
100 hollow fiber membrane sheet
102 hollow fiber membrane
104 hollow fiber membrane bundle
106 fixing part

1. A method of manufacturing a hollow fiber membrane sheet, the method comprising:
accepting a hollow fiber membrane bundle, which is in a sheet state, of a length set in advance in which a plurality of hollow fiber membranes are aligned using one or more accepting means containing a drive roll;
forming fixing parts at which the hollow fiber membranes are fixed in a widthwise direction of the hollow fiber membrane bundle using a fixing means after accepting the hollow fiber membrane bundle of the length set in advance; and
cutting the hollow fiber membrane bundle at the fixing parts or on the vicinity thereof.

2. The method of manufacturing the hollow fiber membrane sheet according to claim 1, wherein at least one of the accepting means is a nip roll pair configured by one pair of rolls.

3. The method of manufacturing the hollow fiber membrane sheet according to claim 1, wherein the number of the accepting means is two, and the fixing means is arranged between the two accepting means.

4. The method of manufacturing the hollow fiber membrane sheet according to claim 1, further comprising:
pulling out a plurality of the hollow fiber membranes from a hollow fiber membrane supplying unit using a pulling-out means,
wherein the plurality of the hollow fiber membranes pulled out by the pulling-out means are accepted as the hollow fiber membrane bundle using the accepting means.

5. The method of manufacturing the hollow fiber membrane sheet according to claim 4, wherein a length of the hollow fiber membranes present from the pulling-out means to the accepting means is configured to be longer than a shortest distance of an actual passage from the pulling-out means to the accepting means by 1 mm or more.

6. The method of manufacturing the hollow fiber membrane sheet according to claim 4, wherein, before the hollow fiber membrane bundle is accepted by using the accepting means, a length of the hollow fiber membranes present from the hollow fiber membrane supplying unit to the accepting means to be longer than a shortest distance of an actual passage from the hollow fiber membrane supplying unit to the accepting means by a length set in advance that is accepted by the accepting means or more.

7. The method of manufacturing the hollow fiber membrane sheet according to claim 4,
wherein the pulling-out means is a movable roll that is movable in a vertical direction between two guide rolls,
wherein, before the hollow fiber membrane bundle is accepted by using the accepting means, by pushing down the hollow fiber membranes stretched over between the two guide rolls using the movable roll, a length of the hollow fiber membranes present between the guide rolls is configured to be longer than a distance between the guide rolls before and after the pulling-out means by a length set in advance that is accepted by the accepting means or more, and
wherein, when the hollow fiber membrane bundle is accepted by using the accepting means, the movable roll is saved so as not to be in contact with the hollow fiber membranes.

8. The method of manufacturing the hollow fiber membrane sheet according to claim 1, wherein a tensile force applied to the hollow fiber membranes present on a further upstream side in a conveyance direction of the hollow membrane bundle than the accepting means is set to a tensile force not stretching the hollow fiber membranes above an allowed range represented below,
wherein the allowed range is an allowed range of a difference between a length of a longest hollow fiber membrane and a length of a shortest hollow fiber membrane in the hollow fiber membrane sheet, and is 0.5% of the length set in advance or less.

9. The method of manufacturing the hollow fiber membrane sheet according to claim 1, wherein a hollow fiber membrane bundle of a sheet state is formed by aligning the plurality of the hollow fiber membranes using an aligning means.

10. A manufacturing apparatus for a hollow fiber membrane sheet, the manufacturing apparatus comprising:
one or more accepting means, which contains a drive roll, accepting a hollow fiber membrane bundle of a sheet state in which a plurality of hollow fiber membranes are aligned;
a fixing means that forms fixing parts at which the hollow fiber membranes are fixed in a widthwise direction of the hollow fiber membrane bundle; and
a control means that accepts the hollow fiber membrane bundle of a length set in advance by operating the accepting means to accept the hollow fiber membrane bundle of the length set in advance and then, stops the accepting means and operates the fixing means.

11. The manufacturing apparatus for a hollow fiber membrane sheet according to claim 10, further comprising a cutting means that cuts the hollow fiber membrane bundle at the fixing parts or on the vicinity thereof.

12. The manufacturing apparatus for a hollow fiber membrane sheet according to claim 10, wherein at least one of the accepting means is a nip roll pair configured by one pair of rolls.

13. The manufacturing apparatus for a hollow fiber membrane sheet according to claim 10, wherein the number of the accepting means is two, and the fixing means is arranged between the two accepting means.

14. The manufacturing apparatus for a hollow fiber membrane sheet according to claim 10, further comprising:
a hollow fiber membrane supplying unit in which the hollow fiber membranes are stored; and
a pulling-out means that pulls out a plurality of hollow fiber membranes from the hollow fiber membrane supplying unit,
wherein the accepting means accepts the plurality of hollow fiber membranes pulled out by the pulling-out means as the hollow fiber membrane bundle.

15. The manufacturing apparatus for a hollow fiber membrane sheet according to claim 14, wherein the control means performs control of the pulling-out means and the accepting means such that a length of the hollow fiber membranes present from the pulling-out means to the accepting means is configured to be longer than a shortest distance of an actual passage from the pulling-out means to the accepting means by 1 mm or more.

16. The manufacturing apparatus for a hollow fiber membrane sheet according to claim 14,
wherein the pulling-out means is a movable roll that is movable in a vertical direction between two guide rolls, and
wherein the control means, while the accepting means is stopped, moves the movable roll to a lower side so as to push down the hollow fiber membranes stretched over between the two guide rolls until a length of the hollow fiber membranes present between the guide rolls becomes longer than a distance between the guide rolls before and after the pulling-out means by a length set in advance that is accepted by the accepting means or more and, while the accepting means is operated, saves the movable roll so as not to be in contact with the hollow fiber membranes.

17. The manufacturing apparatus for a hollow fiber membrane sheet according to claim 10, wherein the control means performs control of the accepting means such that a tensile force applied to the hollow fiber membranes present on a further upstream side in a conveyance direction of the hollow membrane bundle than the accepting means is set to a tensile force not stretching the hollow fiber membranes above an allowed range,
wherein the allowed range is an allowed range of a difference between a length of a longest hollow fiber membrane and a length of a shortest hollow fiber membrane in the hollow fiber membrane sheet, and is 0.5% of the length set in advance or less.

18. The manufacturing apparatus for a hollow fiber membrane sheet according to claim 10, further comprising an aligning means that forms a hollow fiber membrane bundle of a sheet state by aligning the plurality of the hollow fiber membranes.

19. (canceled)
